(19) United States
(12) Patent Application Publication
(10) Pub. No.: US 2013/0151132 A1
(43) Pub. Date: Jun. 13, 2013

(54) REMOTE STARTER

(71) Applicant: FUJITSU TEN LIMITED, Kobe-shi (JP)

(72) Inventors: Satoshi HARUMOTO, Kobe-shi (JP); Ryuji NISHIMURA, Kobe-shi (JP)

(73) Assignee: FUJITSU TEN LIMITED, Kobe-shi (JP)

(21) Appl. No.: 13/691,039

(22) Filed: Nov. 30, 2012

(30) Foreign Application Priority Data
Dec. 9, 2011 (JP) 2011-270071

(51) Int. Cl. F02N 11/08

(52) U.S. Cl. CPC F02N 11/0807
USPC 701/113

(57) ABSTRACT

A remote starter is installed in a vehicle for executing starting control of a driving apparatus of the vehicle, and executes the starting control of the driving apparatus in response to a request for starting received from an information processor that is located outside the vehicle. The remote starter includes a communicator that communicates with the information processor by transmitting and receiving information and a controller that obtains time information at a time of starting the driving apparatus. The communicator transmits the time information at the time of starting to the information processor at the time of starting the driving apparatus in response to the request for starting received from the information processor.

### BACKGROUND OF THE INVENTION

1. Field of the Invention

The invention relates to a technology that implements remote start control on a vehicle by use of a mobile terminal.

2. Description of the Background Art

Conventionally known is a remote starter that controls starting of a driving apparatus such as an engine or a motor of user's vehicle by use of a mobile terminal. By use of this technology, a user can start the driving apparatus of his or her vehicle that is away from the user. Therefore, in an example, the user can turn on an air conditioner to control the temperature of the vehicle cabin to be appropriate before the user gets in his or her vehicle. Known these days is a remote operation system that operates an on-vehicle apparatus of own vehicle via a center by use of a mobile phone as a mobile terminal.

In common case when the user uses the remote starter, the user is far from the vehicle. Therefore, it is impossible for the user to know whether the temperature control in the vehicle cabin has been finished, or how much time is left. In such a case, the user may get in the vehicle before the temperature of the vehicle cabin is to be appropriate. To prevent this, when any request for checking a remaining time or a time corresponding to a remaining time such as an elapsed time after the starting has been made by the user, the center may obtain a remaining time from the vehicle and may let the user to know the obtained remaining time.

However, in this case, the center has to communicate with the vehicle to check a remaining time every time the user makes the request for checking the time corresponding to the remaining time. This causes frequent communications between the center and the vehicle, which may increase communication costs.

### SUMMARY OF THE INVENTION

According to one aspect of the invention, a remote starter is installed in a vehicle and executes starting control of a driving apparatus of the vehicle. The remote starter also executes the starting control of the driving apparatus in response to a request for starting received from an information processor that is located outside the vehicle. The remote starter includes a communicator that communicates with the information processor by transmitting and receiving information and a controller that obtains time information at a time of starting the driving apparatus. The communicator transmits the time information at the time of starting to the information processor at the time of starting the driving apparatus in response to the request for starting received from the information processor.

Since the remote starter obtains the time information at the time of starting and transmits the obtained time information to the information processor at the time of starting the driving apparatus, the information processor can obtain the time information at the time of starting. This enables the information processor to use the time information at the time of starting without communicating with the remote starter even when the time information at the time of starting may be required later. Therefore, the information processor can obtain the time information at the time of starting while reducing communication costs.

According to another aspect of the invention, an information processor is configured to be communicatively coupled to a mobile terminal and a remote starter that is installed in a vehicle, and transmits a request for starting a driving apparatus of the vehicle to the remote starter based on the request for starting received from the mobile terminal. The information processor includes a communicator that communicates with the mobile terminal and the remote starter by transmitting and receiving information. Upon receiving time information at a time of starting the driving apparatus from the remote starter in response to the request for starting transmitted by the communicator to the remote starter, the communicator transmits the time information at the time of starting to the mobile terminal.

The information processor receives the time information at the time of starting the driving apparatus from the remote starter in response to the request for starting transmitted to the remote starter. Upon receiving the time information at the time of starting, the information processor transmits the received time information to the mobile terminal. Therefore, the mobile terminal can obtain the time information at the time of starting without communicating with the remote starter. Since the information processor obtains the time information at the time of starting from the remote starter, the information processor can transmit the obtained time information to the mobile terminal without communicating with the remote starter to newly obtain the time information even when the information processor needs to retransmit the time information to the mobile terminal. Therefore, the information processor can obtain the time information at the time of starting while reducing communication costs.

According to another aspect of the invention, a mobile terminal transmits a request for starting to an information processor which transmits the request for starting to a remote starter executing starting control of a driving apparatus of a vehicle. The mobile terminal includes a communicator that communicates with the information processor by transmitting and receiving information, a timer that measures time and a display that displays information. When the communicator receives time information at a time of starting the driving apparatus from the information processor in response to the request for starting transmitted to the information processor, the timer measures a time corresponding to a remaining time before stopping driving of the driving apparatus based on the time information at the time of starting, and the display displays the time corresponding to the remaining time before stopping the driving of the driving apparatus.

Since the mobile terminal measures the time corresponding to the remaining time before stopping the driving of the driving apparatus based on the time information at the time of starting the driving apparatus received from the information processor and displays the measured time, the mobile terminal is capable of informing the user of the time corresponding to the remaining time before stopping the driving of the driving apparatus.

Therefore, an object of the invention is to provide a technology relevant to remote starting vehicle control that is capable of informing the user of the time corresponding to the driving apparatus's driving remaining time while reducing communication costs.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a schematic vehicle control system.

FIG. 2 shows a block diagram of a remote starter.

FIG. 3 shows a block diagram of a mobile terminal.

FIG. 4 shows a block diagram of a center.

FIG. 5 shows a flowchart of processing on the remote starter.

FIG. 6 shows another flowchart of processing on the remote starter.

FIG. 7 shows another flowchart of processing on the remote starter.

FIG. 8 shows another flowchart of processing on the remote starter.

FIG. 9 shows another flowchart of processing on the remote starter.

FIG. 10 shows another flowchart of processing on the remote starter.

FIG. 11 shows a flowchart of processing on the mobile terminal.

FIG. 12 shows another flowchart of processing on the mobile terminal.

FIG. 13A shows another flowchart of processing on the mobile terminal.

FIG. 13B shows another flowchart of processing on the mobile terminal.

FIG. 14 shows a flowchart of processing on the center.

FIG. 15 shows another flowchart of processing on the center.

FIG. 16 shows another flowchart of processing on the center.

FIG. 17 shows another flowchart of processing on the center.

FIG. 18 shows another flowchart of processing on the center.

FIG. 19 shows another flowchart of processing on the center.

### DESCRIPTION OF THE EMBODIMENTS

Hereinafter, an embodiment of the invention is described with reference to attached drawings.

<1. Outline of System>

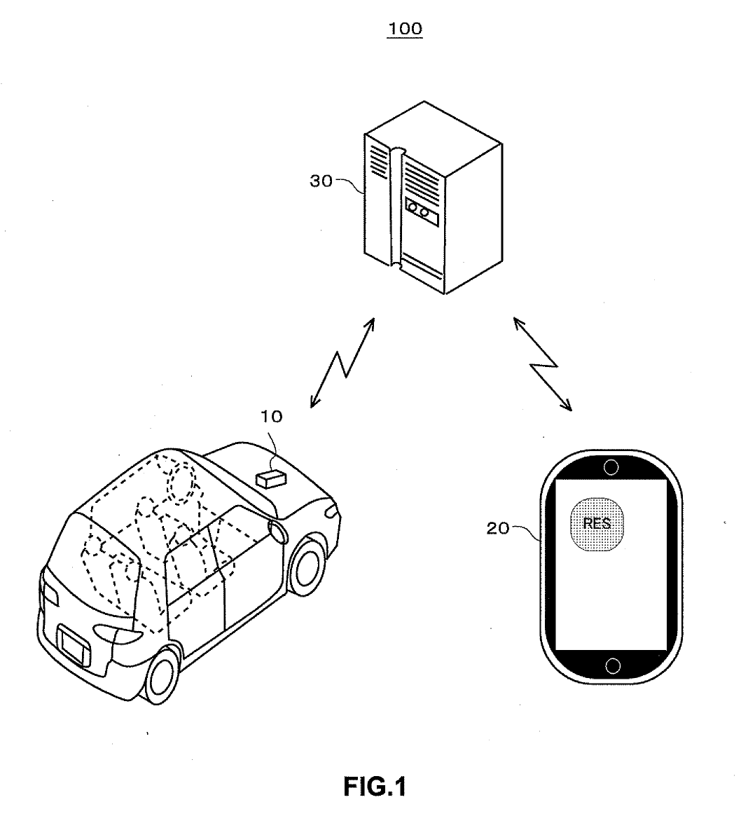

FIG. 1 shows an outline of a remote starter system 100 of the embodiment. The remote starter system 100 includes a remote starter 10, a mobile terminal 20 and a center 30.

The remote starter 10 is installed in a vehicle to control the vehicle in accordance with the control information transmitted by the center 30. The remote starter 10 that is communicatively connected to the center 30 and transmits to the center 30 vehicle information including position information at a predetermined timing, and receives via the center 30 the control information including a request for starting from the mobile terminal 20. Upon receiving the request for starting from the center 30, the remote starter 10 implements controls for starting of a driving apparatus and various apparatuses on the vehicle. Upon starting the driving apparatus of the vehicle, the remote starter 10 obtains time information at a time of starting, and transmits the obtained time information at the time of starting to the center 30 at the time of starting the driving apparatus. Upon starting the driving apparatus of the vehicle by the request for starting received from the center 30, the remote starter 10 automatically stops the driving apparatus after predetermined period of time, that is, warming-up time has elapsed.

The driving apparatus is an engine or a motor. The invention is adaptable to both cases. However, for convenience sake, the embodiment may be described by use of the engine. The various apparatuses are, for example, an air conditioner and a door. That is, the remote starting control controls start/stop of the engine or the motor, on/off operation of the air conditioner, open/close of the door, and the like. In the description below, the target to be remote-started may be indicated simply as a “driving apparatus,” and the action such as start/stop or on/off operation may be indicated simply as “starting.”

The mobile terminal 20 is a mobile electronic device that a user carries, for example, a smartphone, a tablet PC, a mobile phone or a PDA (Personal Digital Assistant). The mobile terminal 20 stores an application for remotely starting the driving apparatus on the vehicle. The user can remotely send the request for starting or make various settings by executing an operation of the application stored in the mobile terminal 20.

The mobile terminal 20 is configured to be communicatively coupled to the center 30, and transmits to the center 30 the request for starting, information on various settings and position information of the mobile terminal 20. Upon obtaining the time information at the time of starting the driving apparatus from the center 30, the mobile terminal 20 displays a time corresponding to remaining time such as the remaining time of driving of the driving apparatus or the elapsed time since beginning of the starting of the driving apparatus. Hereinafter, the case of displaying the driving apparatus's driving remaining time is described as an example.

The center 30 is an information processor that totally controls the remote starter system 100. The center 30 is configured to be communicatively coupled to the remote starter 10 and the mobile terminal 20; and controls start of the driving apparatus by transmitting and receiving the request for starting and the vehicle information mutually. In a concrete example, the center 30 receives from the vehicle the vehicle information including the position information, and receives from the mobile terminal 20 the request for starting and the position information. Upon receiving the request for starting from the mobile terminal, the center 30 makes a control, such as judgment or direction on whether to implement remote starting, based on the position information of the mobile terminal 20 and the position information of the vehicle. Upon obtaining the time information at the time of starting the driving apparatus, the center 30 transmits to the mobile terminal 20 this time information.

As above, in the remote starter system 100 of the embodiment, the remote starter 10 obtains the time information at the time of starting the driving apparatus and transmits the time information to the center 30. The center 30 stores the time information at the time of starting obtained from the remote starter 10 and transmits the obtained time information to the mobile terminal 20. This enables the mobile terminal 20 to obtain the time information from the center 30 without communicating with the remote starter 10. The remote starter system 100 is capable of informing the user of the time information such as the driving apparatus's driving remaining time while reducing communication costs. Hereinafter described are the configuration and the processing on the remote starter system 100.

<2. Configuration of Remote Starter>

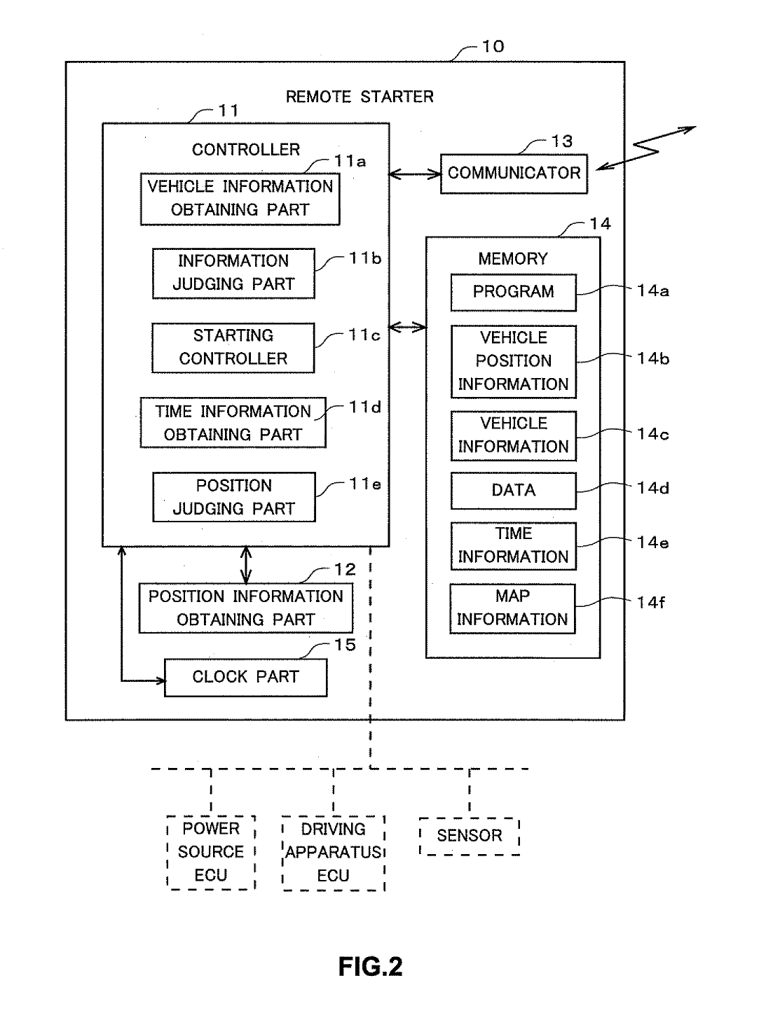

First, the configuration of the remote starter 10 is described. FIG. 2 shows a schematic block diagram of the remote starter 10. As shown in FIG. 2, the remote starter 10 includes a controller 11, a position information obtaining part 12, a communicator 13, memory 14 and a clock part 15.

The controller 11 that includes a vehicle information obtaining part 11a, an information judging part 11b, a starting controller 11c, a time information obtaining part 11d and a position judging part 11e, is a computer that has a CPU, RAM and ROM not shown in FIG. 2. The controller 11 that is connected to the communicator 13 and the memory 14 that are included in the remote starter 10, controls whole of the remote starter 10 by transmitting and receiving information based on a program 14a stored in the memory 14. Arithmetic processing by the CPU based on the program stored in the memory 14 performs the functions of the controller 11, such as the information judging part 11b and the starting controller 11c.

The controller 11 is connected with other various sensors and ECUs (Electronic Control Unit) on the vehicle via an on-vehicle LAN (Local Area Network) such as a CAN (Controller Area Network) so as to communicate with each other for transmitting and receiving various types of information. Since the controller 11 controls the overall processing of the remote starter 10, the controller 11 also controls the processing other than the processing executed by the vehicle information obtaining part 11a, the information judging part 11b, the starting controller 11c and the time information obtaining part 11d described above.

The vehicle information obtaining part 11a obtains the vehicle information as the information indicating driving conditions or the conditions of other ECUs. The vehicle is equipped with various sensors that detect the vehicle driving conditions, such as a vehicle velocity sensor and a steering angle sensor. The vehicle is also equipped with an engine-control-type ECU such as a fuel injection ECU, and a body-control-type ECU such as a door lock/unlock ECU. The vehicle information obtaining part 11a obtains, as the vehicle information, output from the sensors and the ECUs via the CAN.

The information judging part 11b judges the contents of the vehicle information obtained from other sensors and ECUs in the vehicle, and judges the contents of the information received from the center 30. Besides the information described above, the vehicle information includes the information on an ignition being on or off. The information received from the center 30 also includes a command relevant to the request for starting the driving apparatus.

The starting controller 11c controls the starting or the stopping of the driving apparatus and various apparatuses that are installed in the vehicle. That is, the starting controller 11c transmits an applicable direction to the ECU to be controlled upon receiving the command of the request for starting from the center 30. In an example, when receiving from the center 30 the command of the request for starting the driving apparatus, the starting controller 11c transmits via the CAN the direction for starting to the ECU that controls the driving of the driving apparatus. When receiving the command of the request for starting the air conditioner, the starting controller 11c transmits via the CAN the direction for starting to the ECU that controls the driving of the air conditioner.

The time information obtaining part 11d obtains the time information at the time of starting the driving apparatus of the vehicle. The time information at the time of starting is, for example, clock time at the time of starting the driving apparatus by the remote starter (hereinafter, referred to as “starting time”), the remaining time before stopping the driving at the time of starting the driving apparatus by the remote starter (hereinafter, referred to as “remaining time at the time of starting”), and the remaining time before stopping the driving after the starting (hereinafter, simply referred to as “remaining time”).

When a GPS (Global Positioning System) is used as the position information obtaining part 12, the time information obtaining part 11d obtains current time from the time information included in the GPS. However, when the GPS has not obtained the time information, or when the GPS is not used as the position information obtaining part 12, the time information obtaining part 11d obtains the current time from the clock part 15. The current time that has been obtained by the time information obtaining part 11d at the time of starting the driving apparatus corresponds to the starting time. Upon obtaining the starting time, the time information obtaining part 11d transmits the obtained starting time to the center 30 via the communicator 13.

The time information obtaining part 11d also executes the processing for measuring elapsed time. In an example, when driving time at the time of starting the driving apparatus by the remote starter is determined in advance, the time information obtaining part 11d measures the remaining time by starting the processing for subtracting the predetermined time since a point of time of starting the driving apparatus. Further, the time information obtaining part 11d executes the processing for measuring the elapsed time since the starting of the driving apparatus. The elapsed time measured by the time information obtaining part 11d corresponds to the time information for judging whether the elapsed time has reached predetermined driving time.

Upon the vehicle information obtaining part 11a obtaining the information of the ignition being off (that is, parking start information), the position judging part 11e judges whether the vehicle is parked in a restricted area. The restricted area includes a no-idling zone and a specific area. In the no-idling zone, no vehicle is allowed to be kept in the idling condition. In the specific area, it is rare that the remote starter causes the vehicle to idle. That is, the specific area includes the place in which a user almost always comes back to the vehicle in a short time after getting out, such as a rest area and a parking area on an expressway, and a parking area of a convenience store. The information on these areas is included in the map information 14f stored in the memory 14.

The position judging part lie judges whether the vehicle is parked in the no-idling zone, by comparing the map information 14f and the parking start position of the vehicle. When judging that the vehicle is parked in the no-idling zone, the position judging part 11e does not execute the processing for transmitting vehicle position information.

The position judging part 11e identifies where the specific areas are located based on road information and facility information included in the map information 14f stored in the memory 14, and judges whether the vehicle is parked in the specific area based on the vehicle position information. The user may set the specific areas on the map information 14f in advance. The position judging part lie judges whether the vehicle is parked in the specific area, by comparing the specific area and the parking start position of the vehicle. When judging that the vehicle is parked in the specific area, the position judging part 11e forbids the processing for transmitting the vehicle position information. When judging that the vehicle is not parked in the specific area, the position judging part 11e executes the processing for transmitting the vehicle position information.

The user may change the setting regarding whether to forbid or permit the processing for transmitting the vehicle position information when the vehicle is parked in the no-idling zone or in the specific area. Here is an example case where a restriction mode is provided to restrict the processing for transmitting the vehicle position information. In the case where the user activates the restriction mode, transmitting the vehicle position information is forbidden when the vehicle is parked in the restricted area. In the case where the user deactivates the restriction mode, transmitting the vehicle position information is executed wherever the vehicle is parked. The user can activate or deactivate the restriction mode by the mobile terminal 20 via the center 30.

The position information obtaining part 12 obtains the position information indicating the current position of the remote starter 10. For example, the GPS may be used as the position information obtaining part 12. The position information includes latitude information and longitude information. That is, the position information obtaining part 12 obtains the latitude information and the longitude information of the current position by use of the GPS. The position information obtaining part 12 also obtains the time information that is used as the starting time to be obtained by the time information obtaining part 11d.

In some environments where the remote starter 10 is installed, the position information using the GPS is not available. In this case, the position information obtaining part 12 obtains the information indicating that the position information is undetermined (hereinafter, referred to as “undetermined-information”) as the information indicating that the position information is not available.

The position information also indicates the position of a vehicle because the obtained position information indicates the position of the remote starter 10 that is installed in the vehicle. Therefore, the position information obtained by the position information obtaining part 12 is referred to as “vehicle position information,” hereafter. That is, the vehicle position information includes the position information including the latitude information and the longitude information obtained by the GPS, and the undetermined-information when the position information using the GPS is not available. The vehicle position information 14b is stored in the memory 14.

The communicator 13 is communicatively connected to the center 30 for transmitting information to and receiving information from the center 30. In an example, the communicator 13 transmits to the center 30 the vehicle position information, the vehicle information or the time information at the time of starting, that is, the starting time or the remaining time at the time of starting, and receives from the center 30 commands such as a request for communication connection or the request for starting, that is, the control information. Which of the two, the starting time or the remaining time at the time of starting, is adopted as the time information at the time of starting may be determined in advance. Since the starting time is absolute time and unaffected by a delay due to transmission, the remaining time before stopping the driving of the driving apparatus can be measured without error between the remote starter 10 and the mobile terminal 20. In this regard, it is desirable that the starting time be adopted. Communications between the remote starter 10 and the center 30 are through a so-called mobile telephone network. Therefore, the communicator 13 also judges whether the communicator 13 is located in a “service area” where communications with the center are available, or in an “out-of-service area” where communications are not available. Data 14d such as the command transmitted by the center 30 are stored in the memory 14.

The memory 14 stores the program 14a, the vehicle position information 14b, vehicle information 14c, the data 14d, time information 14e and the map information 14f. The memory 14 of the embodiment is nonvolatile semiconductor memory that is capable of reading and writing data electrically, and of keeping data even in power-off state. For example, EEPROM (Electrical Erasable Programmable Read-Only Memory) or flash memory may be used as the memory 14. However, other memory medium or a hard disk drive including a magnetic disk may be used. The program is so-called system software that the controller 11 reads out to execute for controlling the remote starter 10. The time information 14e is, for example, the time information at the time of starting, and the information of the predetermined driving time. The map information 14f includes road information and facility information around the country or in a predetermined wide area.

The clock part 15 is a built-in clock included in the remote starter 10. The clock part 15 includes a so-called clock function, and outputs the time information to the time information obtaining part 11d.

In the embodiment, the memory 14 of the remote starter 10 stores the map information 14f, and the position judging part 11e judges whether the vehicle is parked in the restricted area, which is not limited to this. In an example case where the vehicle is equipped with a navigation apparatus, the map information stored in memory of the navigation apparatus may include the information of the restricted area. In the configuration of this case, the position judging part lie obtains the information of the restricted area from the navigation apparatus, and judges whether the vehicle is parked in the restricted area.

In the embodiment, the specific area is specified by the remote starter 10. However, in another configuration, the specific area may be specified by the center 30, and the specified specific area information may be transmitted to the remote starter 10.

<3. Configuration of Mobile Terminal>

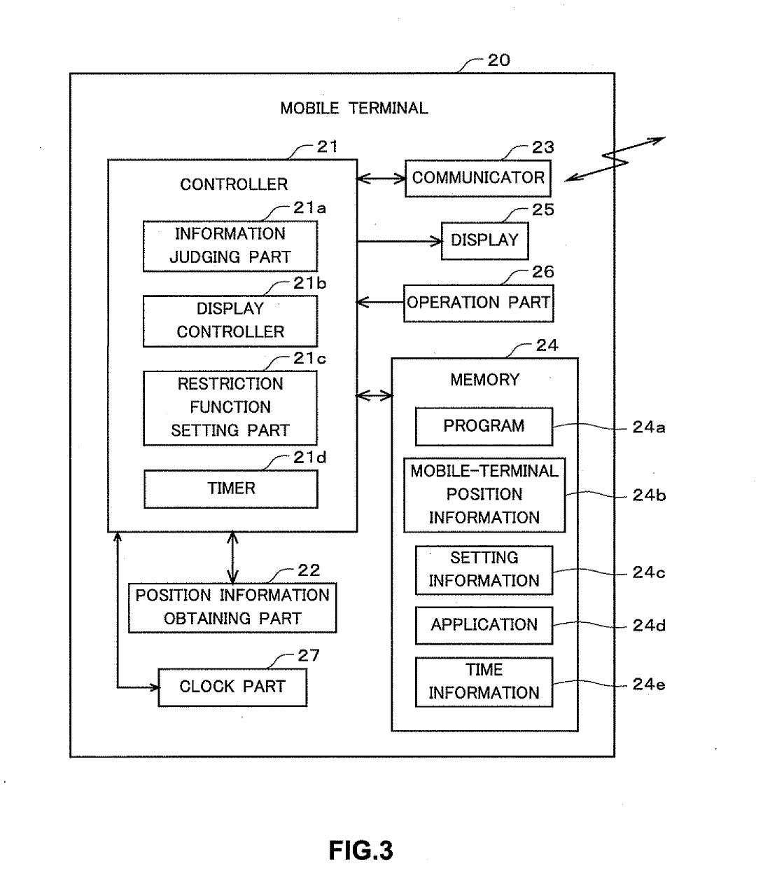

Described next is the configuration of the mobile terminal 20. FIG. 3 shows a schematic block diagram of the mobile terminal 20. As shown in FIG. 3, the mobile terminal 20 includes a controller 21, a position information obtaining part 22, a communicator 23, memory 24, a display 25, an operation part 26 and a clock part 27.

The controller 21 that includes an information judging part 21a, a display controller 21b, a restriction function setting part 21c and a timer 21d, is a computer that has a CPU, RAM and ROM not shown in FIG. 3. The controller 21 that is connected to the communicator 23, the memory 24, and others that are included in the mobile terminal 20, transmits and receives information based on a program 24a stored in the memory 24, and controls whole of the mobile terminal 20. Arithmetic processing by the CPU based on the program stored in the memory 24 performs the functions of the controller 21 such as the information judging part 21a and the display controller 21b. Since the controller 21 controls the overall processing of the mobile terminal 20, the controller 21 also controls the processing other than the processing executed by the information judging part 21a, the display controller 21b, the restriction function setting part 21c and the timer 21d, including execution of the function of the application relevant to the remote starting.

The information judging part 21a judges the contents of the obtained information. In an example, the information judging part 21a judges the contents of the information received from the center 30, and judges the contents of the commands entered via the operation part 26 of the mobile terminal 20. The information received from the center 30 includes, for example, an inquiry relevant to the vehicle information, an inquiry on whether to implement the starting and the time information at the time of starting. The command entered via the operation part 26 of the mobile terminal 20 includes, for example, the command of the request for starting or stopping the driving apparatus.

The display controller 21b makes control so as to display an image on the display 25 of the mobile terminal 20. Concretely, the display controller 21b makes control to display on the display 25 an operation screen for receiving direction for starting the driving apparatus, a check screen received from the center 30 or the remaining time.

The restriction function setting part 21c activates or deactivates the function that restricts the remote starting processing (hereinafter, referred to as “restriction function”) of the driving apparatus of the vehicle when predetermined conditions are met. The predetermined conditions are the conditions that determine whether to execute the remote starting function of the driving apparatus of the vehicle (hereinafter, referred to as “restriction conditions”). The restriction function setting part 21c has a function to change the restriction conditions as well. One of the restriction conditions may relate to the distance between the mobile terminal at the time of the request for starting and the vehicle at the time of parking start. The restriction function based on this restriction condition is indicated as “distance-restriction function.” Another one of the restriction conditions relates to the difference between the vehicle positions at the time of parking start and at the time of the request for starting. The restriction function based on this restriction condition is referred to as “position-restriction function.” Further, another one of the restriction conditions may relate to whether the door of the vehicle is locked, or whether a gear is set at a parking position.

The information indicating the restriction function activated or deactivated and the restriction conditions (hereinafter, referred to as “setting information” collectively) are stored in the memory 24. When the user selects a setting mode by operating the mobile terminal, setting information 24c is read out from the memory 24 and displayed on the display 25. The user can make new setting information in terms of the displayed setting information by activating or deactivating the restriction function, or by changing the conditions in accordance with a change screen. The new setting information is transmitted to the center 30 as well as being stored in the memory 24. The setting information 24c may not be stored in the memory 24 of the mobile terminal 20, but be stored only in the memory 33 of the center 30. In this case, the restriction function setting part 21c reads out the setting information from the memory 33 of the center 30.

The timer 21d measures the driving time of the driving apparatus. That is, upon obtaining the time information at the time of starting from the center 30, the timer 21d obtains the current time and measures the driving time by use of the obtained information. Concretely, in the case of obtaining the starting time from the center 30, the timer 21d calculates the elapsed time by comparing with the current time. Then, the timer 21d calculates the remaining time based on the elapsed time and the predetermined driving time, and continues to count the remaining time by executing the subtraction processing. In the ease of obtaining the remaining time at the time of starting from the center 30, the timer 21d simply executes the subtraction processing and continues to count the remaining time. When the GPS is used as the position information obtaining part 22, the timer 21d obtains the current time from the GPS. When the GPS is not used, the timer 21d obtains the current time from the clock part 27.

The position information obtaining part 22 obtains the position information indicating the current position of the mobile terminal 20 (hereinafter, referred to as “mobile-terminal position information”). For example, the GPS may be used as the position information obtaining part 22. The mobile-terminal position information includes latitude information and longitude information. That is, the position information obtaining part 22 obtains the latitude information and the longitude information of the current position by use of the GPS. The obtained mobile-terminal position information 24b is stored in the memory 24. The position information obtaining part 22 also obtains the time information that is used as the current time to be obtained by the timer 21d.

The communicator 23 is communicatively connected to the center 30 for transmitting information to and receiving information from the center 30. In an example, the communicator 23 transmits to the center 30 the command of the request for starting or the mobile-terminal position information, and receives from the center 30 the command of the request for communication connection or an inquiry on whether to implement the starting, the starting time and the remaining time at the time of starting. Communications between the mobile terminal 20 and the center 30 are through the so-called mobile telephone network. Therefore, the communicator 23 also judges whether the communicator 23 is located in the “service area” where communications with the center 30 are available, or in the “out-of-service area” where communications are not available.

The memory 24 stores a program 24a, the mobile-terminal position information 24b, the setting information 24e, an application 24d and time information 24e. The memory 24 of the embodiment is nonvolatile semiconductor memory that is capable of reading and writing data electrically, and of keeping data even in power-off state. For example, EEPROM or flash memory may be used as the memory 24. However, other memory medium or a hard disk drive including a magnetic disk may be used. The program 24a is so-called system software that the controller 21 reads out to execute for controlling the mobile terminal 20. The application 24d is a control program for the remote starting function. The time information 24e is, for example, the time information at the time of starting, and the information of the predetermined driving time.

The display 25 displays the operation screen of the application for controlling the remote starting function, the check screen on which the user checks the vehicle information transmitted by the center 30 or the remaining time. For example, a liquid crystal display and an organic EL display are used as the display 25.

The operation part 26 is an information input apparatus including a mechanical button and a touch panel. The user can make various operations relevant to the control of the remote starting function, and set or change the setting information, by operating the operation part 26. The operation part 26 may be configured as a unit of the display 25.

The clock part 27 is a built-in clock included in the mobile terminal 20. The clock part 27 includes a so-called clock function, and outputs the time information to the timer 21d.

<4. Configuration of Center>

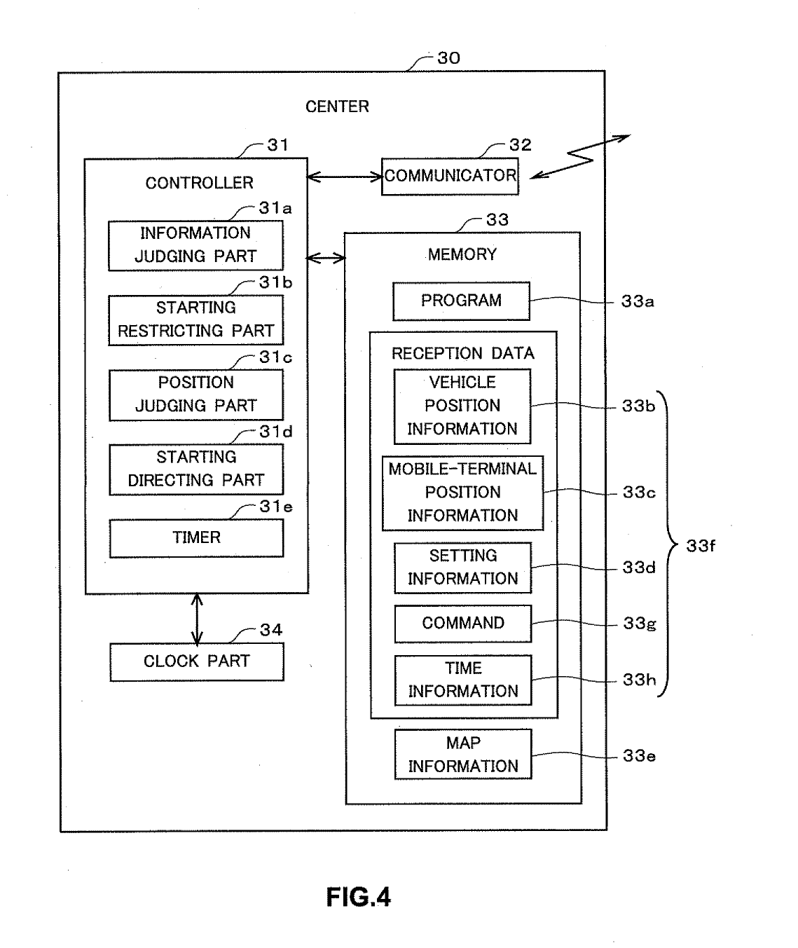

Next, the configuration of the center 30 is described. FIG. 4 shows a schematic block diagram of the center 30. As shown in FIG. 4, the center 30 includes a controller 31, a communicator 32, memory 33 and a clock part 34.

The controller 31 that includes an information judging part 31a, a starting restricting part 31b, a position judging part 31c, a starting directing part 31d and a timer 31e is a computer that has a CPU, RAM and ROM not shown in FIG. 4. The controller 31 that is connected to the communicator 32, the memory 33 and others that are included in the center 30, transmits and receives information based on a program stored in the memory 33, and controls whole of the center 30. Arithmetic processing by the CPU based on the program 33a stored in the memory 33 performs the functions of the controller 31 such as the information judging part 31a and the starting restricting part 31b. Since the controller 31 controls the overall processing of the center 30, the controller 31 also controls the processing other than the processing executed by the information judging part 31a, the starting restricting part 31b, the position judging part 31c, the starting directing part 31d and the timer 31e.

The information judging part 31a judges the contents of the information or the command received from the remote starter 10 or the mobile terminal 20. Concretely, the information judging part 31a judges whether the information received from the remote starter 10 is the vehicle position information or the information indicating starting of the driving apparatus or the information on the ignition being on/off or the time information at the time of starting. The information judging part 31a also judges whether the information received from the mobile terminal 20 is the mobile-terminal position information, the command of the request for starting or stopping the driving apparatus, or the change information of the setting information.

Upon reception of the command of the request for starting from the mobile terminal 20, the starting restricting part 31b judges whether to restrict the starting of the driving apparatus based on the setting information. Concretely, upon the judgment that the command of the request for starting has been received from the mobile terminal 20, the starting restricting part 31b judges whether to start the driving apparatus based on the vehicle position information, the mobile-terminal position information and the setting information.

Here is an example of the case where the distance-restriction function is activated, and the restriction conditions are set based on the distance between the vehicle position at the time of parking start and the position of the mobile terminal at the time of the request for starting. The starting restricting part 31b obtains the distance between the vehicle position at the time of parking start and the position of the mobile terminal at the time of the request for starting based on the vehicle position information and the mobile-terminal position information, and judges whether to restrict the starting of the driving apparatus by comparing the obtained distance and the restriction conditions.

More concretely, the starting restricting part 31b compares vehicle position information 33b at the time of the ignition switched off read out from the memory 33 (that is, the vehicle position information at the time of parking start) and mobile-terminal position information 33c received from the mobile terminal 20 (that is, the mobile-terminal position information at the time of the request for starting), and calculates the distance between each other. Then, the starting restricting part 31b reads out from the memory 33 a restriction distance included in setting information 33d, and judges whether the calculated distance is equal to or longer than the restriction distance. The restriction distance is one of the restriction conditions, in terms of the distance for restricting the starting.

The starting restricting part 31b continues the processing for starting the driving apparatus when the calculated distance is shorter than the restriction distance, and restricts the processing for starting when the calculated distance is equal to or longer than the restriction distance. The restriction of the processing for starting includes forbiddance of the processing for starting. That is, the processing for restricting the processing for starting is, for example, to cancel the processing for starting when forbidding the processing for starting, and to confirm with the user whether to continue the processing for starting when restricting the processing for starting.

Here is another example of the case where the position-restriction function is activated, and the restriction conditions are set based on the difference between the vehicle positions at the time of parking start and at the time of the request for starting. The starting restricting part 31b judges whether to restrict the starting of the driving apparatus based on the vehicle position information at the time of parking start and the vehicle position information at the time of the request for starting.

Concretely, the starting restricting part 31b judges the difference between the vehicle position information 33b at the time of the ignition being switched off read out from the memory 33 (that is, the vehicle position information at the time of parking start) and the vehicle position information 33b obtained from the remote starter 10 when the command of the request for starting is received from the mobile terminal 20 (that is, the vehicle position information at the time of the request for starting), by comparing them with each other. Then, the starting restricting part 31b reads out from the memory 33 the restriction conditions included in the setting information 33d, and compares the read-out restriction conditions and the result of the judged difference. One of the restriction conditions restricts the starting when the two of the vehicle position information are different.

Under this condition, upon the judgment that the two of the vehicle position information are different, the starting restricting part 31b restricts the processing for starting. That is, the judgment that the two of the vehicle position information are different indicates that the vehicle has moved from the position at the time of parking start to the position at the time of the request for starting. The assumed factor of the vehicle having moved is that the vehicle has been stolen or towed away. Therefore, when the two of the vehicle position information are different, the starting restricting part 31b forbids the starting or restricts the starting such as by confirming with the user whether to continue the processing for starting.

Upon reception of the command of the request for starting from the mobile terminal 20, the position judging part 31c judges whether the vehicle is parked in the no-idling zone. The no-idling zone is, as described above, the zone in which no vehicle is allowed to be kept in the idling condition. The information of plural no-idling zones is included in map information 33e stored in the memory 33. The position judging part 31c judges whether the vehicle is parked in the no-idling zone by comparing the map information 33e and the parking start position of the vehicle read out from the memory 33. Upon the judgment that the vehicle is parked in the no-idling zone, the position judging part 31c does not execute the processing for starting.

If it is forbidden that the remote starter 10 transmits to the center 30 the parking position information when the vehicle is parked in the no-idling zone, this processing is not needed originally. However, since the user can change the setting of transmission processing forbidden or permitted in the embodiment, this processing is needed.

The position judging part 31c judges whether the vehicle is parked in the specific area, as well. The specific area is, as described above, the area in which the remote starting function rarely allows the vehicle to idle, and in which the user almost always comes back in a short time to the vehicle after getting out of the vehicle.

The position judging part 31c identifies where the specific areas are located based on the road information and the facility information of the map information 33e stored in the memory 33, and judges whether the vehicle is parked in the specific area based on the vehicle position information. The user may set the specific areas in the map information 33e in advance. The position judging part 31c judges whether the vehicle is parked in the specific area by comparing the specific area and the parking start position of vehicle read out from the memory 33. The position judging part 31c restricts the processing for starting when judging that the vehicle is parked in the specific area, and continues the processing for starting when judging that the vehicle is not parked in the specific area.

If it is forbidden that the remote starter 10 transmits to the center 30 the parking position information when the vehicle is parked in the specific area, this processing is not needed originally. However, since the user can change the setting of transmission processing forbidden or permitted in the embodiment, this processing is needed.

The starting directing part 31d makes the final decision on whether to execute the remote starting function based on the judgment results of the starting restricting part 31b and the position judging part 31c, and executes the processing for transmitting the command of the request for starting to the remote starter 10. Concretely, upon the reception of the command of the request for starting from the mobile terminal 20, both of the starting restricting part 31b and the position judging part 31c judge whether to continue the processing for starting. When both of them judge that the processing for starting is to be continued, the starting directing part 31d makes the final decision to execute the remote starting, and transmits the command of the request for starting to the remote starter 10.

The timer 31e executes the processing for measuring the driving time of the driving apparatus based on the obtained time information at the time of starting. For example, the timer 31e obtains the starting time from the remote starter 10. The timer 31e also obtains the current time from the clock part 34. Then, the elapsed time of the driving of the driving apparatus is measured based on the starting time and the current time. Further, the timer 31e calculates the remaining time based on the elapsed time and the predetermined driving time, and may continue to count the remaining time by executing the subtraction processing.

The timer 31e is provided on the assumption that the mobile terminal 20 does not have the timer 21d. That is, the center 30 receives from the remote starter 10 the time information at the time of starting, and the remaining time based on the time information is calculated by the center 30 or by the mobile terminal 20. Since both cases are assumed, the remaining time may be calculated by at least one of either the center 30 or the mobile terminal 20. However, in the case where the remaining time is calculated by the timer 31e of the center 30, the mobile terminal 20 needs to transmit an inquiry to the center 30 when the user checks the remaining time, which causes communication costs between the mobile terminal 20 and the center 30 and causes response delay due to the communication. In this regard, if the remaining time is calculated by the timer 21d of the mobile terminal 20, the mobile terminal 20 need not communicate with the center 30 when the user checks the remaining time, which results in no communication costs and no response delay. Therefore, it is desirable that the remaining time be calculated by the mobile terminal 20. However, since the remaining time is not calculated when the mobile terminal 20 has not succeeded in receiving the time information at the time of starting accurately due to deterioration of radio wave condition, it is important that the remaining time is also calculated by the center 30 as a backup.

The communicator 32 is configured to be communicatively coupled to the remote starter 10 and the mobile terminal 20 by transmitting and receiving information respectively. In an example, the communicator 32 transmits to the remote starter 10 the command of the request for starting, and to the mobile terminal 20 the information for confirming whether to continue the processing for starting or the time information at the time of starting. In another example, the communicator 32 receives from the remote starter 10 the vehicle position information and the vehicle information, and from the mobile terminal 20 the mobile-terminal position information and the command of the request for starting. Communications between the remote starter 10 and the mobile terminal 20 are through the so-called mobile telephone network.

The memory 33 stores the program 33a, the vehicle position information 33b, the mobile-terminal position information 33c, the setting information 33d, the map information 33e, a command 33g and time information 33h. In description, reception data 33f may be used for collective indication of the vehicle position information 33b, the mobile-terminal position information 33c, the setting information 33d, the command 33g and the time information 33h. In an adaptable configuration, the command 33g may be stored in the memory 33 so as to be read out when needed for execution, or may not be stored in the memory 33 and be executed upon reception. The time information 33h is, for example, the time information at the time of starting, and the information of the predetermined driving time.

The memory 33 of the embodiment is nonvolatile semiconductor memory that is capable of reading and writing data electrically, and of keeping data even in power-off state. For example, EEPROM or flash memory may be used as the memory 33. However, other memory medium or a hard disk drive including a magnetic disk may be used. The program 33a is so-called system software that the controller 31 reads out to execute for controlling the center 30. The map information 33e includes the road information and the facility information around the country or in a predetermined wide area.

The clock part 34 is a built-in clock included in the center 30. The clock part 34 includes a so-called clock function, and outputs the time information to the timer 31e.

<5. Processing on Remote Starter>

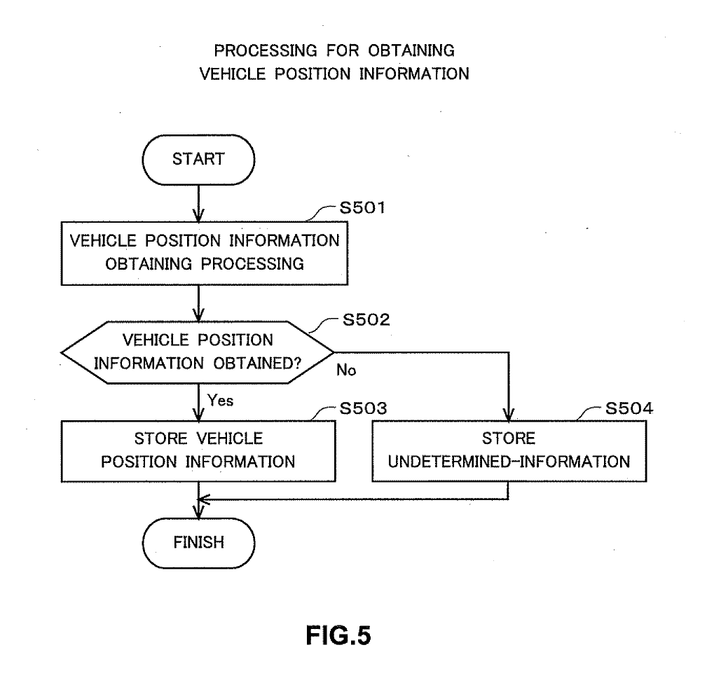

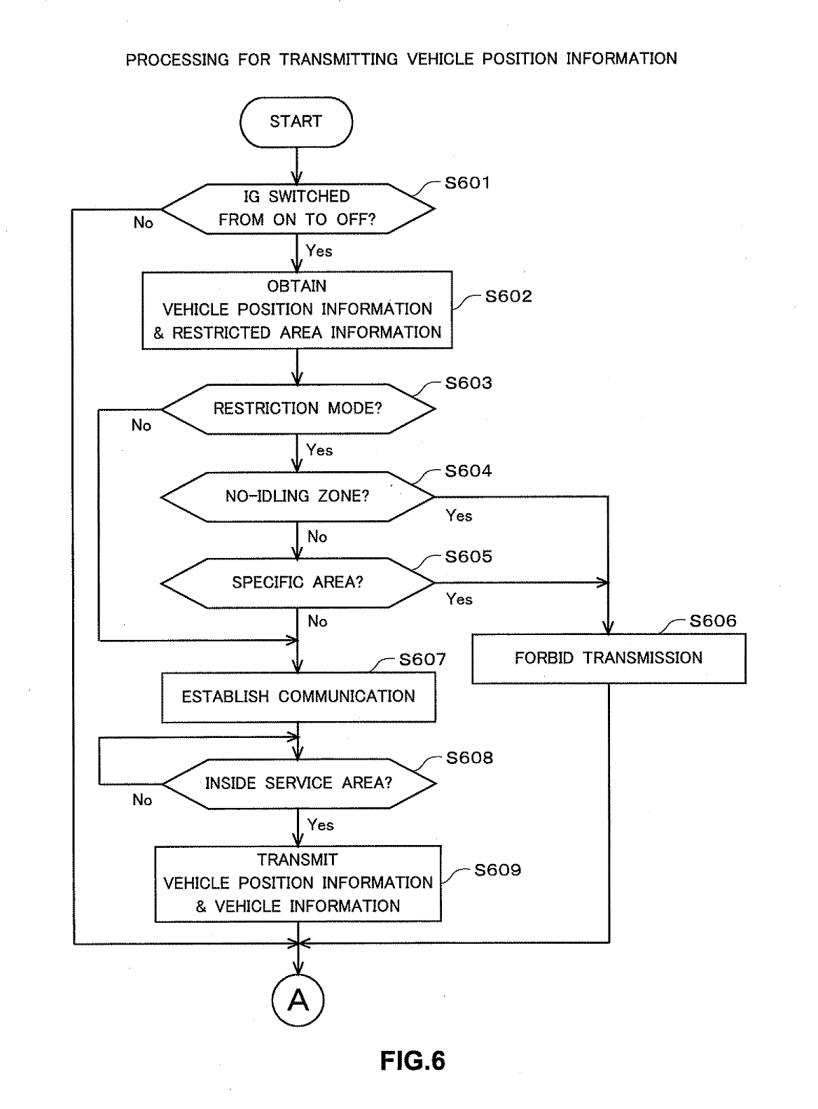

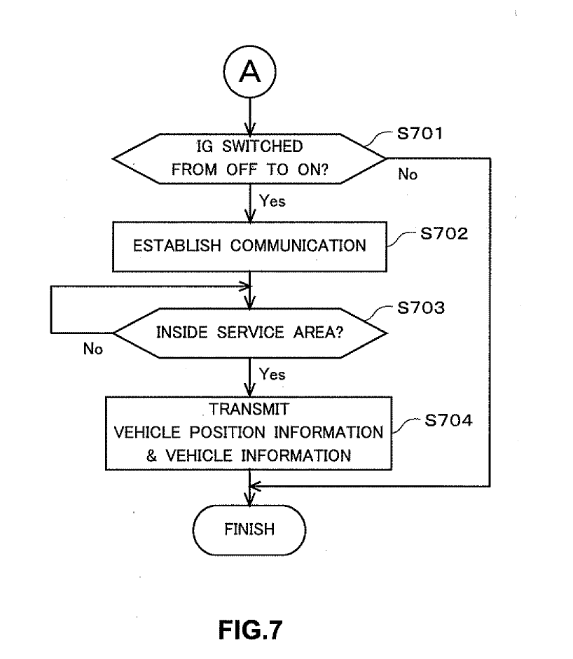

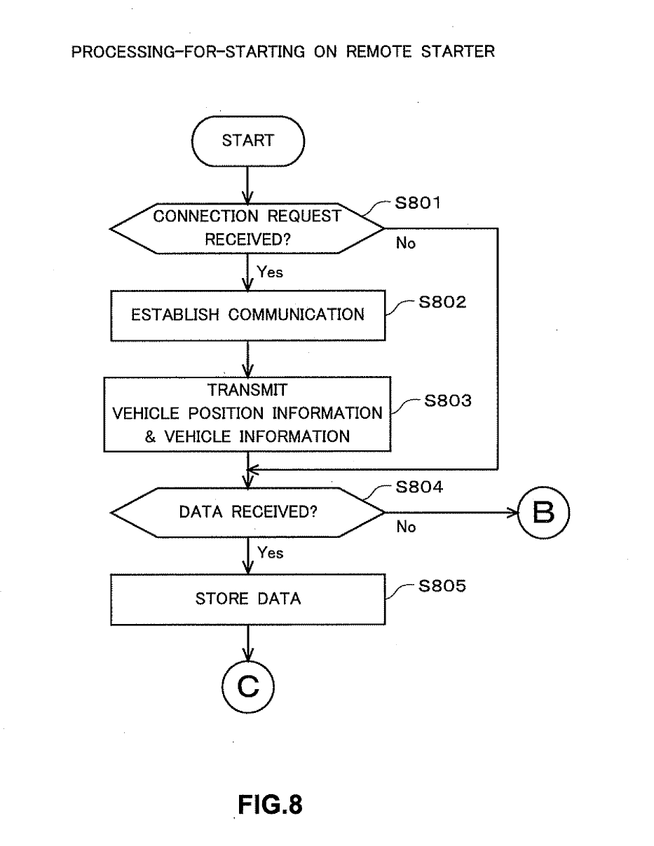

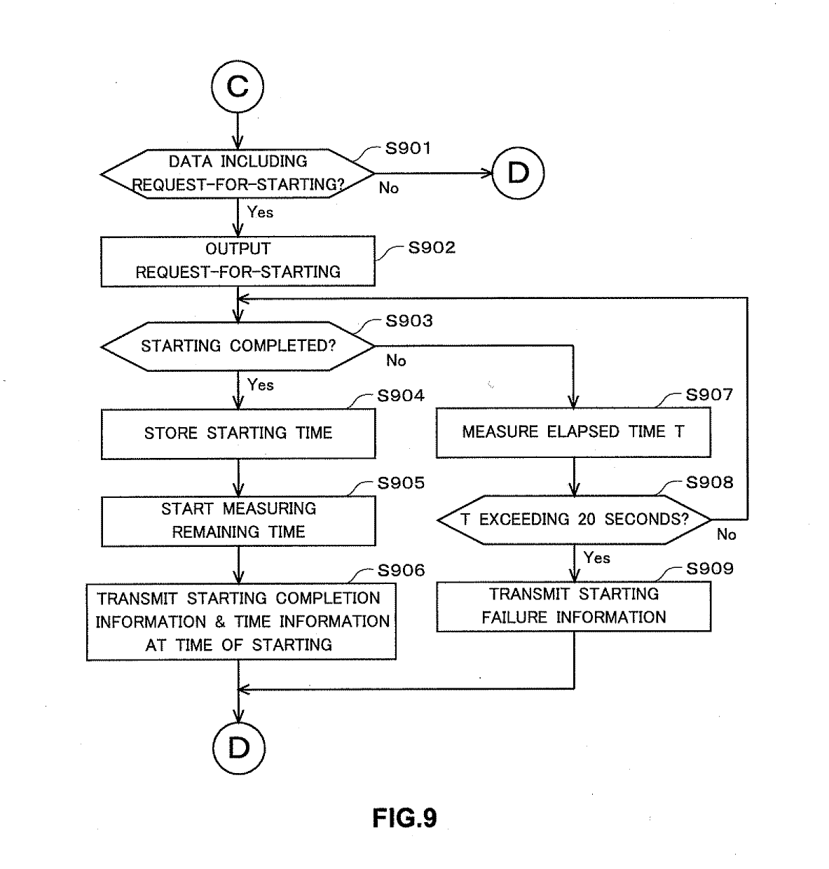

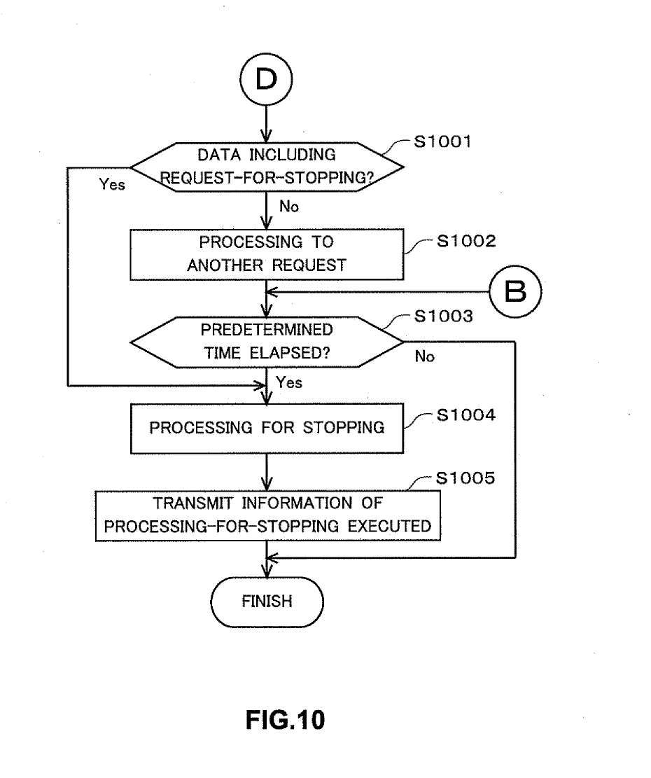

Described next is the processing on the remote starter 10. Each of FIG. 5, FIG. 6, FIG. 7, FIG. 8, FIG. 9 and FIG. 10 shows a flowchart of the processing on the remote starter 10.

The remote starter 10 obtains the vehicle position information periodically while the ignition of the vehicle is in the on-state. Here, described is the processing on the remote starter 10 for obtaining the vehicle position information. FIG. 5 shows the flowchart of the processing on the remote starter 10 for obtaining the vehicle position information.

First, the position information obtaining part 12 executes the processing for obtaining the vehicle position information, for example, every 50 ms or 100 ms (step S501). After executing the processing for obtaining the vehicle position information, the position information obtaining part 12 judges whether the vehicle position information has been obtained (step S502). The vehicle position information includes the latitude information and the longitude information. Thus, in an example, when the position information obtaining part 12 has succeeded in appropriately obtaining the latitude information and the longitude information, it is judged that the vehicle position information has been obtained. When the position information obtaining part 12 has not succeeded in obtaining them appropriately, it is judged that the vehicle position information has not been obtained.

In the case of judging that the vehicle position information has been obtained (Yes at the step S502), the position information obtaining part 12 stores the obtained vehicle position information in the memory 14 (step S503). When judging that the vehicle position information has not been obtained (No at the step S502), the position information obtaining part 12 stores the undetermined-information in the memory 14 (step S504). In this case, the undetermined-information corresponds to the vehicle position information. The remote starter 10 repeats the same processing on a regular basis for obtaining the vehicle position information.

When ignition condition is manually switched to the on-state or to the off-state, the remote starter 10 executes the processing for transmitting the vehicle position information and the vehicle information to the center 30 in the case where the vehicle is parked outside the restricted area. Described next is the processing on the remote starter 10 for transmitting the vehicle position information and the vehicle information. Each of FIG. 6 and FIG. 7 shows the flowchart of the processing on the remote starter 10 for transmitting the vehicle position information and the vehicle information to the center 30. In the figures, the ignition is indicated as “IG”.

First, the vehicle information obtaining part 11a detects whether the ignition condition has been manually switched from the on-state to the off-state (step S601). Concretely, upon reception via CAN from a power source ECU, of the signal indicating that the ignition is in the off-state while the ignition is in the on-state, the vehicle information obtaining part 11a detects that the ignition has been switched from the on-state to the off-state.

When the vehicle information obtaining part 11a does not detect the ignition condition has been switched from the on-state to the off-state (No at the step S601), the procedure moves to the step described later for detecting whether the ignition condition has been switched from the off-state to the on-state (A in FIG. 6).

In the case where the vehicle information obtaining part 11a detects that the ignition condition has been switched from the on-state to the off-state (Yes at the step S601), it is judged that the vehicle is now to be parked. Then, the controller 11 obtains the vehicle position information and the restricted area information (step S602). Concretely, the controller 11 obtains the restricted area information from the map information 14f in the memory 14, and as well, the vehicle position information at the time of parking start from the position information obtaining part 12. The restricted area information includes the no-idling zones and the specific areas.

The controller 11 judges whether the restriction mode that restricts the processing for transmitting the vehicle position information is on (step S603). When the restriction mode is not on (No at the step S603), the procedure moves to the step for transmitting the vehicle position information (step S607).

In the case where the restriction mode is on (Yes at the step S603), the position judging part 11e judges whether the vehicle is in the no-idling zone (step S604). That is, the position judging part 11e judges whether the parking start position of the vehicle is in the no-idling zone, by comparing the vehicle position information obtained at the step S602 and the no-idling zones included in the restricted area information. In the case where the position judging part 11e judges that the parking start position of the vehicle is in the no-idling zone (Yes at the step S604), the vehicle is not to be kept in the idling condition by the remote starting function. Thus, the processing for transmitting the vehicle position information is forbidden (step S606), and the procedure moves to the next step (A in FIG. 6).

When judging that the parking start position of the vehicle is not in the no-idling zone (No at the step S604), the position judging part 11e judges whether the parking start position of the vehicle is in the restricted area (step S605). Concretely, the position judging part 11e judges whether the parking start position of the vehicle is in the specific area, by comparing the vehicle position information obtained at the step S602 and the specific areas included in the restricted area information.

In the case where the position judging part lie judges that the parking start position of the vehicle is in the specific area (Yes at the step S605), it is assumed that the remote starting function is rarely executed. Thus, the processing for transmitting the vehicle position information is forbidden (step S606), and the procedure moves to the next step (A in FIG. 6). When the position judging part 11e judges that the parking start position of the vehicle is not in the specific area (No at the step S605), the procedure moves to the next step where the controller 11 transmits the vehicle position information.

The controller 11 establishes communications with the center 30 (step S607). Concretely, the controller 11 transmits the command of the request for communication connection to the center 30 via the communicator 13. Upon reception of the command of the request for communication connection, the center 30, if available, permits the communication connection to establish the communication.

However, when the vehicle is parked in the area where communications are not available, establishing communications at a step S607 is impossible. Therefore, the communicator 13 judges whether the vehicle is in the service area where communications with the center 30 are available (step S608). That is, when communications have been established at the step S607, the communicator 13 judges that the vehicle is in the service area for communications. When communications have not been established, the communicator 13 judges that the vehicle is in the out-of-service area for communications.

In the case of judging that the vehicle is in the service area for communications (Yes at the step S608), the communicator 13 transmits to the center 30 the vehicle position information and the vehicle information (step S609). The vehicle position information to be transmitted is the position information obtained by the position information obtaining part 12 when the ignition condition has been switched off, that is, the parking start position information. The vehicle information to be transmitted is the information obtained by the vehicle information obtaining part 11a when the ignition condition has been switched to the off-state, and includes the information indicating that the ignition is in the off-state. The vehicle information to be transmitted may include the vehicle information that is stored in the memory 14 but has not been transmitted, besides the information indicating that the ignition is in the off-state.

When judging that the vehicle is not in the service area for communications (No at the step S608), the communicator 13 judges once again whether the vehicle is in the service area. This is because the communication conditions may have been temporarily bad due to bad weather or surround constructions. If so, there is a possibility that the communication conditions are improved later. When the vehicle is not in the service area, the controller 11 cannot transmit the vehicle position information and others to the center 30. Therefore, the controller 11 stores the information to be transmitted in the memory 14, and after it is judged that the vehicle is in the service area when the communication conditions are improved, executes the processing for transmitting to the center 30 via the communicator 13 the vehicle position information and the vehicle information read out from the memory 14. However, when the communication conditions are changed from the condition of being in the out-of-service area to the condition of being in the service area, the controller 11 may obtain the new vehicle position information. When it is judged that the newly-obtained vehicle position information corresponds to the vehicle position information at the time when the ignition is switched off, which is stored in the memory 14, based on the comparison between the two, the controller 11 may transmit the newly-obtained vehicle position information to the center 30.

Next, the vehicle information obtaining part 11a detects whether the user manually has switched the ignition condition from the off-state to the on-state (step S701). Concretely, upon reception via CAN from the power source ECU, of the signal indicating that the ignition is in the on-state while the ignition is in the off-state, the vehicle information obtaining part 11a detects that the ignition condition has been switched from the off-state to the on-state.

When the vehicle information obtaining part 11a does not detect that the ignition condition has been switched from the off-state to the on-state (No at the step S701), the procedure is finished without any execution of the processing.

In the case of detecting that the ignition condition has been switched from the off-state to the on-state (Yes at the step S701), the vehicle information obtaining part 11a judges that the vehicle is not to be parked any more. Then, the controller 11 establishes communications with the center 30 (step S702). Concretely, the controller 11 transmits the command of the request for communication connection to the center 30 via the communicator 13. Upon reception of the command of the request for communication connection, the center 30, if available, permits the communication connection to establish the communication. When communications with the center 30 have been established already, the processing can be omitted.

After communications have been established, the communicator 13 periodically judges whether the vehicle is in the service area where communications with the center 30 are available (step S703). That is, as well as the above, the communicator 13 judges whether communications with the center 30 are available by monitoring deterioration of the communication condition when communications with the center 30 have been established.

In the case of judging that the vehicle is in the service area for communications (Yes at the step S703), the communicator 13 transmits to the center 30 the vehicle position information and the vehicle information (step S704). The vehicle position information to be transmitted is the position information obtained by the position information obtaining part 12 when the ignition condition has been switched on, that is, the position information at the time of parking end. The vehicle information to be transmitted is the information obtained by the vehicle information obtaining part 11a when the ignition condition has been switched on, and includes the information indicating that the ignition is in the on-state. The vehicle information to be transmitted may include the vehicle information that is stored in the memory 14 but has not been transmitted, besides the information indicating that the ignition is in the on-state.

When judging that the vehicle is not in the service area for communications (No at the step S703), the communicator 13 judges once again whether the vehicle is in the service area. Since the communicator 13 cannot transmit the vehicle position information and others to the center 30 when the vehicle is not in the service area, the controller 11 stores the information to be transmitted in the memory 14. Then, the controller 11, after it is judged that the vehicle is in the service area, executes the processing for transmitting to the center 30 via the communicator 13 the vehicle position information and the vehicle information read out from the memory 14.

As above, when the ignition condition is manually changed to the off-state, in the case where the vehicle is parked outside the restricted area, the remote starter 10 executes the processing for transmitting to the center 30 the vehicle position information obtained at the time when the ignition condition is changed to the off-state, besides the information indicating that the ignition is in the off-state. The remote starter 10 executes the processing shown in FIG. 6 and FIG. 7 periodically, for example, every 50 ms or 100 ms.

Described next is the processing on the remote starter 10 for starting the driving apparatus. Each of FIG. 8, FIG. 9 and FIG. 10 shows a flowchart of the processing for starting on the remote starter 10.

First, the controller 11 judges whether the request for connection has been transmitted by the center 30 (step S801). The controller 11 makes this judgment based on the judgment whether the command of the request for communication connection has been received from the center 30 via the communicator 13. When the controller 11 judges that the request for communication connection has not been received (No at the step S801), the procedure moves to the step for judging whether any data have been received (step S804). In the case of judging that connection request has been received (Yes at the step S801), the controller 11, if available, permits the communication connection to establish communication (step S802).

After the communication is established, the controller 11 obtains the current vehicle position information by starting up the position information obtaining part 12, and the current vehicle information from the vehicle information obtaining part 11a. Then, the controller 11 transmits the obtained current vehicle position information and the current vehicle information to the center 30 via the communicator 13 (step S803). The vehicle position information in this case is the position information obtained by the position information obtaining part 12 when the command of the request for communication connection is received from the center 30. The vehicle information in this case is the vehicle information obtained by the vehicle information obtaining part 11a when the command of the request for communication connection is received, and the vehicle information stored in the memory 14 but not having been transmitted. In this processing, the controller 11 may transmit only the vehicle position information, not the vehicle information.

Next, the controller 11 judges whether any data have been received from the center 30 (step S804). When the controller 11 judges that any data have not been received (No at the step S804), the procedure moves to the step, described later, for judging whether the predetermined period of time has elapsed (through B in FIG. 8 to step S1003).

When judging that some data have been received (Yes at the step S804), the controller 11 stores the received data 14d in the memory 14 (step S805), and the procedure moves to the next step (C in FIG. 8). The information judging part 11b may store the data 14d in the memory 14 after judging the contents of the data, or may store the data 14d without the judgment. The received data include various kinds of commands, for example, the commands of the request for starting the driving apparatus and various apparatuses, and commands of the request for transmitting the vehicle position information and the vehicle information.

Next, the information judging part 11b judges whether the data received from the center 30 include the command of the request for starting the driving apparatus (step S901). The information judging part 11b makes this judgment by judging the contents of the received data. When the contents of the received data are judged for storage in the memory 14, another processing for judging whether the command of the request for starting is stored in the memory 14 may be executed instead.

When the information judging part 11b judges that the received data do not include the command of the request for starting the driving apparatus (No at the step S901), the starting controller 11c does not output the request for starting, and the procedure moves to the next step (D in FIG. 9).

When the received data include the command of the request for starting the driving apparatus (Yes at the step S901), the starting controller 11c outputs the request for starting the driving apparatus (step S902). Concretely, when the command of the request for starting is received, the starting controller 11c transmits the signal of the request for starting via CAN to the power source ECU. The power source ECU makes an ACC relay, an ignition relay and a starter relay be in the on-state, and transmits an ACC signal, an ignition signal and a starter signal to an engine ECU. When receiving these signals, the engine ECU starts a starter motor to start an engine. This enables remote control to start the engine. In the case of the vehicle equipped with a so-called immobilizer, the starting controller 11c executes the processing for certification with the ECU that controls the immobilizer.

Upon outputting the request for starting the driving apparatus, the starting controller 11c judges whether the starting has been completed (step S903). Even if the engine ECU executes the processing for starting the starter motor, engine starting sometimes ends in failure. Therefore, the starting controller 11c judges whether the engine has been actually started. In this case, the starting controller 11c can judge whether the engine has been actually started by receiving from the engine ECU the signal indicating that the engine has been started.

When the starting controller 11c judges that the starting of the driving apparatus has been completed (Yes at the step S903), the time information obtaining part 11d obtains the starting time and stores the obtained starting time in the memory 14 (step S904). Upon obtaining a judgment result of starting completion from the starting controller 11c, the time information obtaining part 11d can obtain the starting time by obtaining the current time from the GPS. By obtaining the actual starting time instead of the clock time when outputting the request for starting, the driving time of the driving apparatus and the remaining time can be measured accurately. Contrary to above description, when the current time cannot be obtained from the GPS, the current time is obtained from the clock part 15 as the starting time.

Next, the time information obtaining part 11d starts measuring the remaining time (step S905). That is, upon obtaining the judgment result of the starting completion of the driving apparatus, the time information obtaining part 11d, in a periodically-executed subroutine not shown in FIG. 9, reads out the predetermined driving time from the time information 14e in the memory 14, and measures the remaining time by executing the subtraction processing.

Then, the starting controller 11c and the time information obtaining part 11d transmit to the center 30 via the communicator 13 the information indicating that the starting of the driving apparatus has been completed and the time information at the time of starting (step S906), and the procedure moves to the next step (D in FIG. 9). That is, the remote starter 10 transmits the time information at the time of starting to the center 30 at the time of starting the driving apparatus. Only the starting time may be transmitted to the center 30 as the time information to be transmitted to the center 30. Also, the starting time and the remaining time at the time of starting may be transmitted to the center 30. By sending the remaining time at the time of starting together, the remaining time is calculated even when the mobile terminal 20 does not have information of warming-up time.

When the starting controller 11c judges that the starting of the driving apparatus has not been completed (No at the step S903), the time information obtaining part 11d measures elapsed time T since the point of outputting the request for starting (the point of time when the engine ECU has started the starter motor) (step S907). Then, the time information obtaining part 11d judges whether the elapsed time T exceeds 20 seconds (step S908).

When the time information obtaining part 11d judges that the elapsed time T does not exceed 20 seconds (No at the step S908), the starting controller 11c re-judges whether the starting has been completed (step S903). This is because starting control is continued until the elapsed time T exceeds about 20 seconds after the output of the request for starting, and there is a possibility that the starting succeeds. Therefore, the starting controller 11c re-monitors whether the starting has been completed. The elapsed time T is not limited to 20 seconds. An appropriate period of time such as 30 seconds or 60 seconds is permitted to be set.

When the time information obtaining part 11d judges that the elapsed time T exceeds 20 seconds (Yes at the step S908), the starting controller 11c judges that the starting of the driving apparatus has been ended in failure, and transmits starting failure information to the center 30 via the communicator 13 (step S909). Then, the procedure moves to the next step (D in FIG. 9).

In the embodiment, when the starting controller 11c judges that the starting of the driving apparatus has been completed, the starting time is obtained and transmitted to the center 30, which is not limited to this. In an adaptable configuration, the starting controller 11c may obtain the current time at the time of outputting the request for starting the driving apparatus, and may transmit to the center 30 the obtained time as the starting time. In this case, after the processing of the step S902 is executed, the processing of the step S904 is executed.

In this configuration, since the point of outputting the request for starting is nearly regarded as the point of time when the starting of the driving apparatus has been completed, although the driving time of the driving apparatus and the remaining time are not measured exactly, approximate time can be measured.

Next, the information judging part 11b judges whether the data received from the center 30 include the command of the request for stopping the driving apparatus (step S1001). The information judging part 11b makes this judgment by judging the contents of the received data, as well. When the received data include the command of the request for stopping the driving apparatus (Yes at the step S1001), the starting controller 11c executes the processing for stopping the driving apparatus (step S1004). The processing for stopping is described later.

When the information judging part 11b judges that the data received from the center 30 do not include any command of the request for stopping the driving apparatus (No at the step S1001), the starting controller 11c executes the processing corresponding to another request without execution of the processing for stopping at this point (step S1002). The processing corresponding to another request is executed when the received data include a command other than the ones of the request for starting and stopping the driving apparatus (hereafter, referred to as “another command”), as a response to the received another command.

That is, the information judging part 11b judges whether the received data include another command. The starting controller 11c executes processing as the response to the command, if any. In an example, when the received data include the command for locking a door, the starting controller 11c executes the processing for locking the door. When the received data include the command for unlocking the door, the starting controller 11c executes the processing for unlocking the door. When the received data include the command of the request for transmitting the vehicle information, the starting controller 11c executes the processing for transmitting the requested vehicle information to the center 30 via the communicator 13. When the information judging part 11b judges that the received data do not include any another command, there is nothing to be done at this step.

Next, the time information obtaining part 11d judges whether the predetermined period of time has elapsed since the starting of the driving apparatus (step S1003). The time information obtaining part 11d starts measuring time from the starting of the driving apparatus, and judges whether the predetermined period of time has elapsed. The predetermined period of time is, for example, a certain amount of elapsed time since the starting of the driving apparatus, that is, a predetermined so-called warming-up time. For example, 10 minutes may be set as the warming-up time. Or, 20 minutes at maximum may be set as the total time of multiple warming-up operations. However, the predetermined period of time is not limited to these above. An appropriate period of time is permitted to be set.

When the time information obtaining part 11d judges that the predetermined period of time has elapsed since the starting (Yes at the step S1003), the starting controller 11c executes the processing for stopping the driving apparatus (step S1004). In an example of the processing for stopping, the starting controller 11c transmits the signal for stopping to the power source ECU via CAN, and the power source ECU makes the ACC relay, the ignition relay and the starter relay be in the off-state to stop the engine drive. This enables remote control to stop the engine.

Then, after executing the processing for stopping the driving apparatus, the controller 11 transmits to the center 30 via the communicator 13 the information indicating that the processing for stopping has been executed (step S1005), and the procedure for the processing for remote starting is finished.

When the time information obtaining part 11d judges that the predetermined period of time has not elapsed (No at the step S1003), the procedure of the processing for remote starting is finished without execution of the processing for stopping.

After the communication with the center 30 has been established, the center 30 executes the processing for terminating the communication. The processing for termination on the center 30 is described later.

<6. Processing on Mobile Terminal>

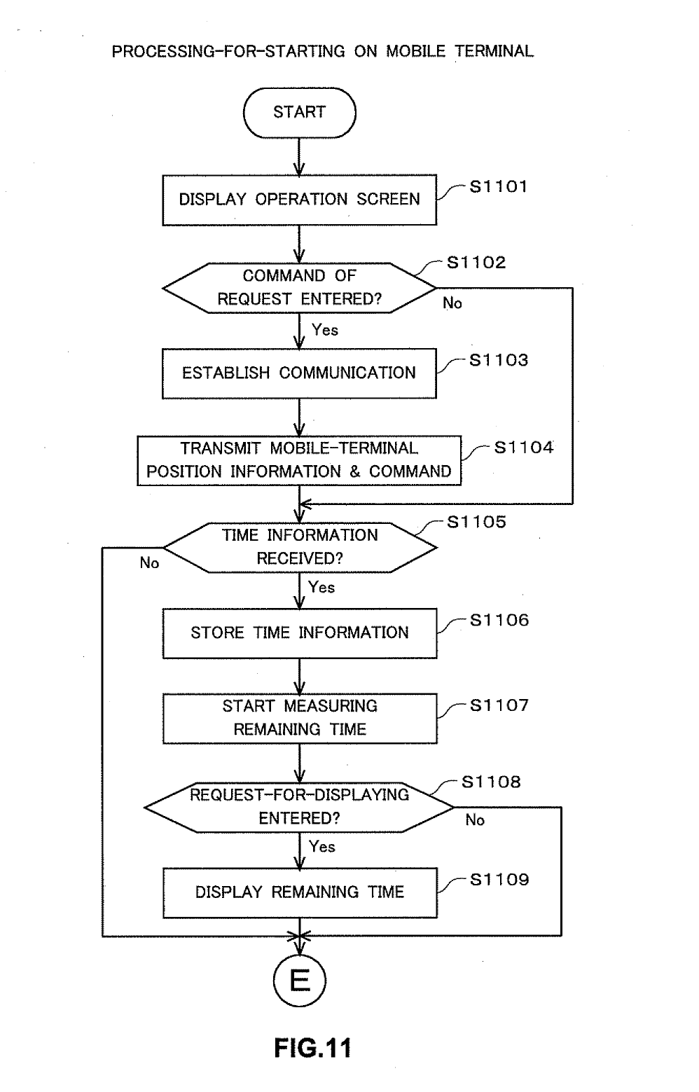

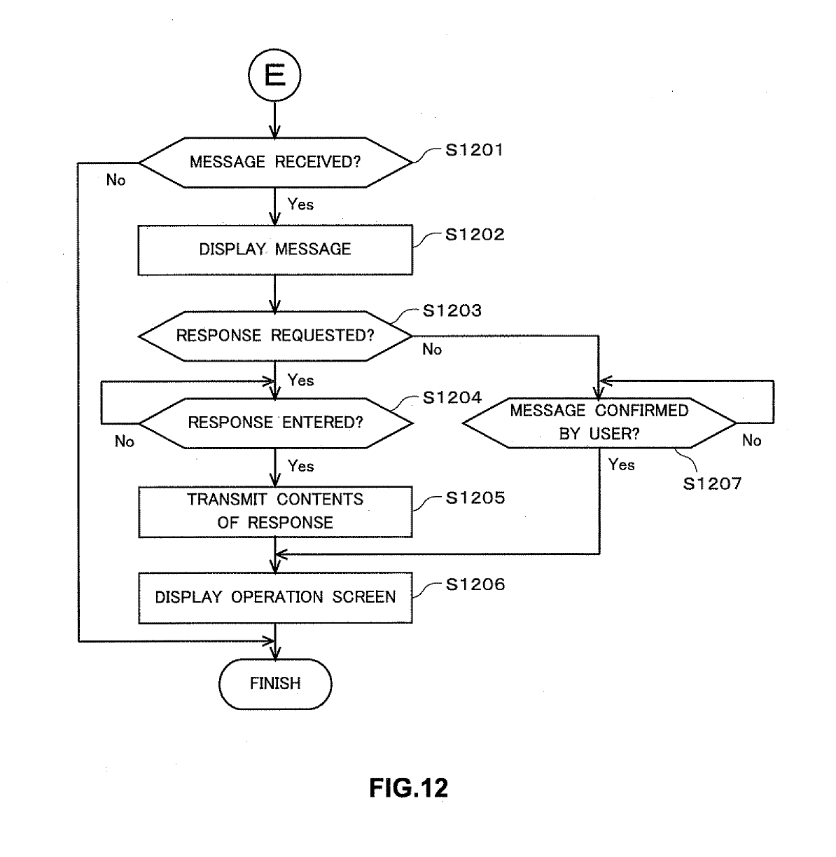

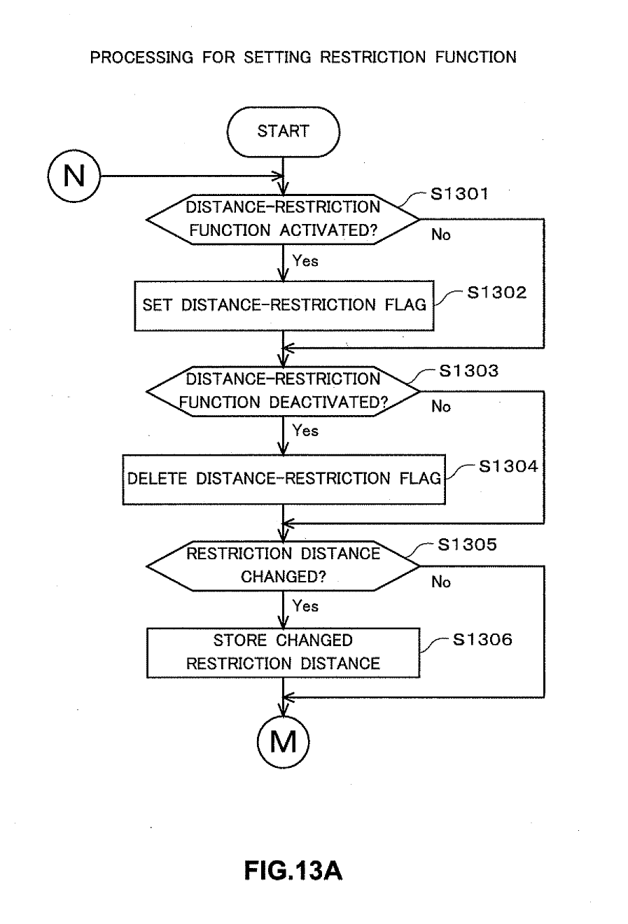

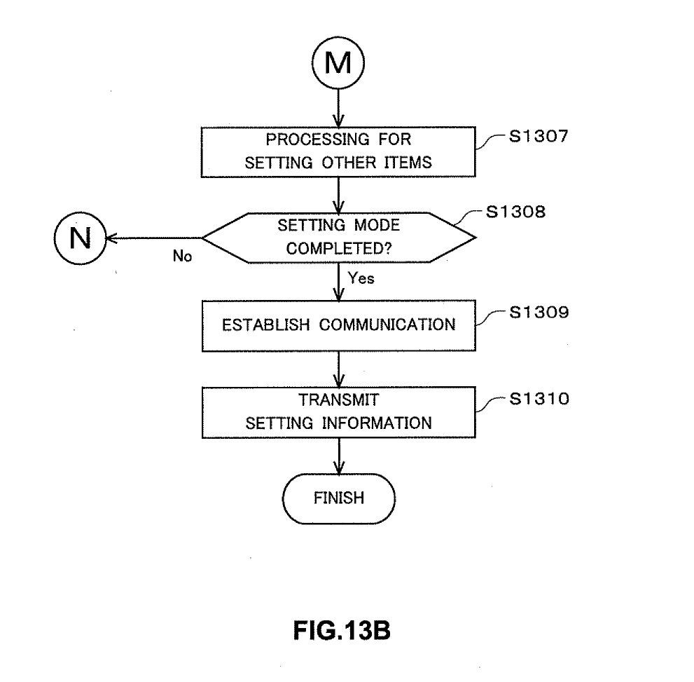

Next, the processing on the mobile terminal 20 is described. Each of FIG. 11, FIG. 12, FIG. 13A and FIG. 13B shows a flowchart of the processing on the mobile terminal 20. Described first is the processing for remote starting by use of the mobile terminal 20. Each of FIG. 11 and FIG. 12 shows a flowchart of the processing for remote starting on the mobile terminal 20.

The remote starting processing by the mobile terminal 20 starts with running the application 24d for remote starting stored in the mobile terminal 20. After the application 24d of the mobile terminal 20 is run, a main operation screen for operation for remote starting is displayed on the display 25 (step S1101). The display controller 21b displays the operation screen on the display 25 by reading out the operation screen stored in the application 24d.

Next, the controller 21 judges whether any command of a request to the center 30 has been entered by the operation of the user on the displayed operation screen (step S1102). When the controller 21 judges that the command of a request has been entered, the information judging part 21a judges the contents of the entered command. The command to be entered is, for example, of the request for starting or stopping the driving apparatus.

When judging that the command of a request has been entered (Yes at the step S1102), the controller 21 establishes the communication with the center 30 (step S1103). Concretely, the controller 21 transmits the command of the request for communication connection to the center 30 via the communicator 23. Upon reception of the command of the request for communication connection, the center 30, if available, permits the communication connection to establish the communication.

Next, the controller 21 transmits the entered request command to the center 30 via the communicator 23 (step S1104). Prior to transmission of the entered request command, the position information obtaining part 22 obtains the position information of the mobile terminal 20. Then, the controller 21 transmits the obtained mobile-terminal position information besides the entered request command. When the controller 21 judges that the request command has not been entered (No at the step S1102), the procedure moves to the next step without any execution of the processing for transmitting the request command or others.

Next, the controller 21 judges whether the time information at the time of starting has been received from the center 30 (step S1105). The information judging part 21a makes this judgment. When the information judging part 21a judges that the time information at the time of starting has not been received (No at the step S1105), the procedure moves to the next step without any execution of the processing to respond to the judgment (E in FIG. 11). When judging that the time information at the time of starting has been received (Yes at the step S1105), the information judging part 21a stores the received time information in the memory 24 as the time information 24e (step S1106).

Next, the timer 21d starts measuring the remaining time (step S1107). That is, when the starting time is received as the time information at the time of starting, the timer 21d, in a periodically-executed subroutine not shown in FIG. 11, reads out the starting time and the predetermined driving time, that is, the information of warming-up time from the time information 24e in the memory 24, and also obtains the current time from the GPS or the clock part 27. Then, the timer 21d calculates from the starting time and the current time the elapsed time since the driving apparatus has been driven. Next, the timer 21d calculates the remaining time by subtracting the elapsed time from the predetermined driving time. Then, the timer 21d continues the subtraction processing, and continues to count real-time remaining time.

Next, the controller 21 judges whether any command of a request for displaying the remaining time has been entered by the operation of the user (step S1108). When judging that the command of the request for displaying has been entered (Yes at the step S1108), the controller 21 displays the remaining time on the display 25 (step S1109). The remaining time that is counted in real time by the timer 21d is displayed on the display 25. That is, the remaining time is displayed in a countdown state. Therefore, the user can always check the actual remaining time by entering the command of the request for displaying the remaining time. After the controller 21 displays the remaining time, the procedure moves to the next step (E in FIG. 11).

When the controller 21 judges that the command of the request for displaying the remaining time has not been entered (No at the step S1108), the procedure moves to the next step (E in FIG. 11).

When the user shuts down the application for remote starting and when the user turns off the mobile terminal 20, during execution of the remote starting, there is a possibility that the time information at the time of starting disappears. As above, in the case where the time information at the time of starting has disappeared by any cause, the mobile terminal 20 may establish the communication with the center 30 again when the user restarts the application for remote starting, and may obtain the time information at the time of starting stored in the center 30. That is, the processing starting from the step S1103 is executed.

Next, the controller 21 judges whether any messages have been received from the center 30 (step S1201). Here, the controller 21 makes the judgment including whether any data have been received from the center 30, and whether the received data, if any, are messages. Concretely, the information judging part 21a makes this judgment on whether the received data are messages. The messages to be received from the center 30 are, for example, a confirmation message relevant to continuation of the processing for remote starting, and a response message to the information requested by the user to the center. Concretely, these messages are, for example, the confirmation message for confirming whether to continue the starting in the case where the restriction conditions for the restriction function are not satisfied, and the response message for transmitting the contents of the vehicle information that has been inquired by the user to the center.

When the controller 21 judges that the message has not been received (No at the step S1201), the procedure of the processing for remote starting is finished without any execution of the following processing. When judging that the message has been received (Yes at the step S1201), the controller 21 displays the message on the display 25 (step S1202).

The information judging part 21a judges whether the received message is for requesting user's response (step S1203). The message for requesting user's response, in the example described above, is the confirmation message for confirming whether to continue the starting. The message not for requesting user's response is the response message for transmitting the contents of the vehicle information.

When the information judging part 21a judges that the received message is for requesting user's response (Yes at the step S1203), the controller 21 monitors whether the user's response has been entered (step S1204). The response is entered when the user makes operations on the operation screen. The step for monitoring the user's response is repeated until when it is judged that the response has been entered (No at the step S1204).

When judging that the response has been entered (Yes at the step S1204), the controller 21 transmits the contents of the response to the center via the communicator 23 (step S1205). Then, the controller 21 redisplays the operation screen on the display 25 (step S1206).

When the information judging part 21a judges that the received message is not for requesting the user's response at the step for judging the existence of the response request (No at the step S1203), the controller 21 monitors whether the user has confirmed the displayed message (step S1207). The message not for requesting the user's response is only for presenting the contents to the user. Thus, the controller 21 monitors simply whether the user has confirmed the message. However, the step for monitoring may be omitted, if not needed.

The controller 21 repeats the step for monitoring until it is judged that the user has confirmed the message (No at the step S1207). When judging that the user has confirmed the message (Yes at the step S1207), the controller 21 redisplays the operation screen on the display 25 (step S1206). In an example, the user touches a confirmation button on the operation screen to express confirmation of the message. In this case, the controller 21 judges whether the message has been confirmed by judging whether the confirmation button has been touched.

Later, the user can execute again the processing for remote starting by re-executing the processing from the start. The user can complete the processing for remote starting by shutting down the application 24d for remote-controlling.

The communications with the center 30 are terminated not just when the application 24d for remote-controlling is shut down, but are automatically terminated when transmitting necessary data to and receiving necessary data from the center 30 are completed. That is, communications are automatically terminated in the case where it is judged that after the controller 21 has established communications at the step S1103, a series of responses from the center in terms of the request command transmitted at the step S1104 have been completed. The case where the responses from the center 30 have been completed is the case such as where time information at the time of starting has been received or where a message not for requesting the user's response has been received.

Described next is the processing for setting the restriction function and for changing the restriction conditions by use of the mobile terminal 20. Each of FIG. 13A and FIG. 13B shows a flowchart of the processing for setting the restriction functions and for changing the restriction conditions in the case where the distance-restriction function is adopted as the restriction function.

The processing for setting the restriction functions and for changing the restriction conditions starts when the user selects the setting mode of the mobile terminal. When the setting mode is selected, the restriction function setting part 21c judges whether the distance-restriction function of the mobile terminal 20 is activated (step S1301). When the distance-restriction function is activated (Yes at the step S1301), the restriction function setting part 21c sets the flag indicating that the distance-restriction function is activated (step S1302). When the distance-restriction function is not activated (No at the step S1301), the flag is not set.

Next, the restriction function setting part 21c judges whether the distance-restriction function is deactivated (step S1303). When the distance-restriction function is deactivated (Yes at the step S1303), the restriction function setting part 21c deletes the flag for activating the distance-restriction function (step S1304). When the distance-restriction function is not deactivated (No at the step S1303), the flag is not deleted.

Next, the restriction function setting part 21c judges whether the restriction distance as the one of the restriction conditions has been changed (step S1305). In the case where the restriction distance has been changed (Yes at the step S1305), the restriction function setting part 21c stores the restriction distance after change in the memory 24 (step S1306). Then, the procedure moves to the next step (M in FIG. 13A). In the case where the restriction distance is not changed (No at the step S1305), the processing for changing the restriction conditions is not executed (M in FIG. 13A).

Next, the restriction function setting part 21c executes the processing for setting other items (step S1307). The processing for setting other items is for setting or changing the restriction conditions other than the restriction distance. One of the restriction conditions other than the restriction distance includes the conditions relevant to the position-restriction function. When the processing for setting or changing the restriction conditions other than the restriction distance is executed, the restriction function setting part 21c stores the setting or the restriction conditions after change in the memory 24. When the processing for setting or changing is not executed, this step can be omitted.

Next, the restriction function setting part 21c judges whether the setting mode has been completed (step S1308). When the restriction function setting part 21c judges that the setting mode has been completed (Yes at the step S1308), the controller 21 establishes the communication with the center 30 (step S1309). The communication is established in the same manner as the processing described above. When the communication with the center 30 has been established already, this step can be omitted.

The controller 21 transmits to the center 30 via the communicator 23 the setting information 24c read out from the memory 24 after completion of the processing for setting (step S1310), and then, the procedure of the processing for setting the restriction functions and for changing the restriction conditions is finished. When judging that the setting mode has not been completed (No at the step S1308), the restriction function setting part 21c re-executes the procedure starting from the processing for judging whether the distance-restriction function is activated (through N in FIG. 13B to the step S1301).

<7. Processing on Center>

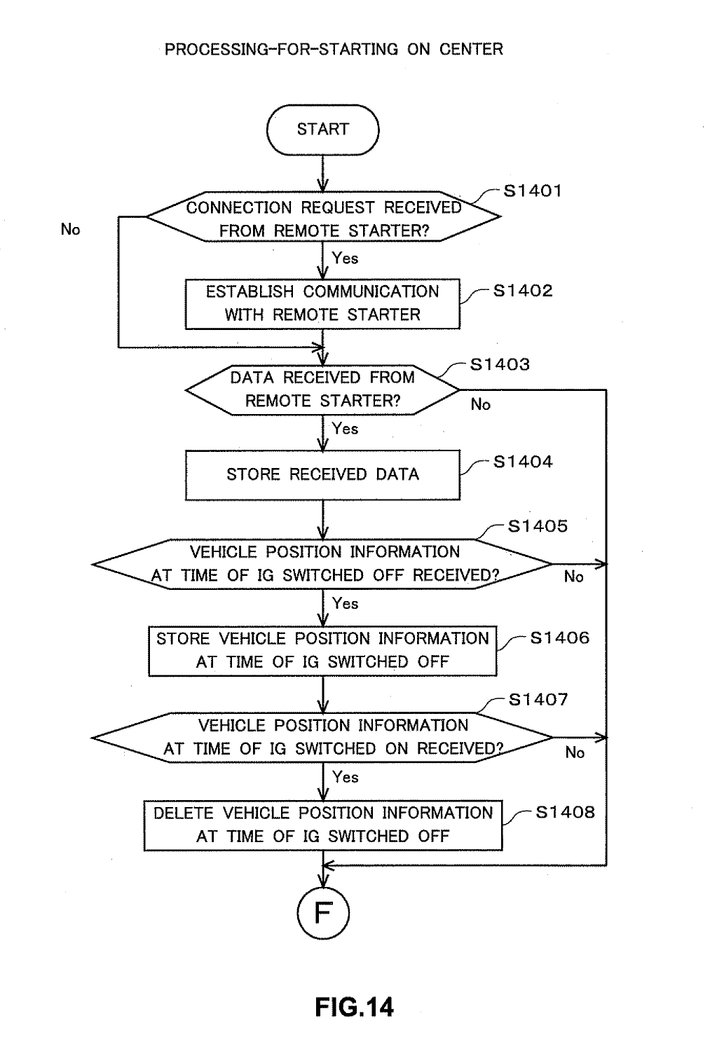

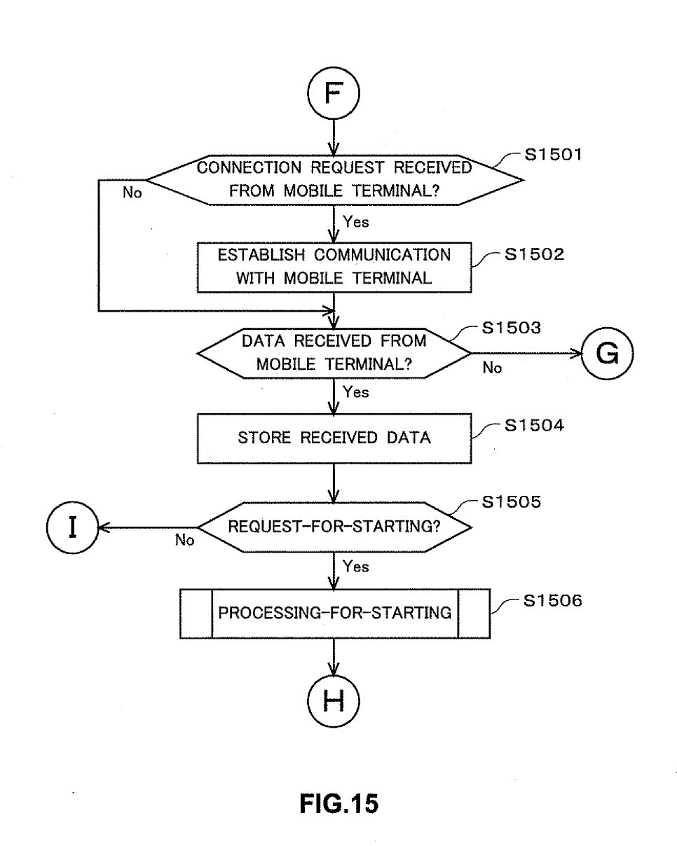

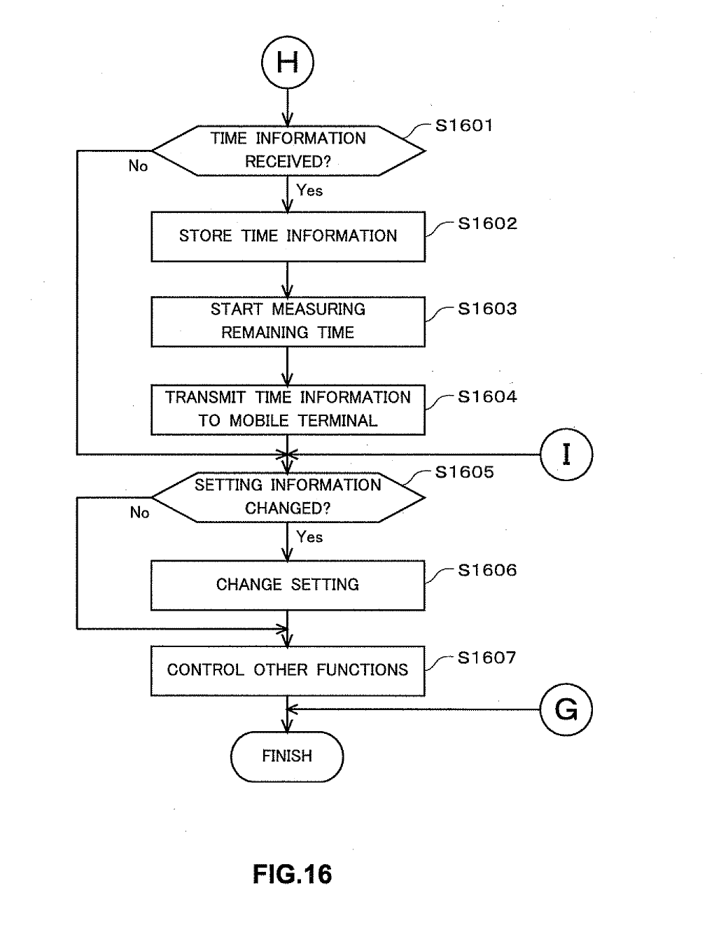

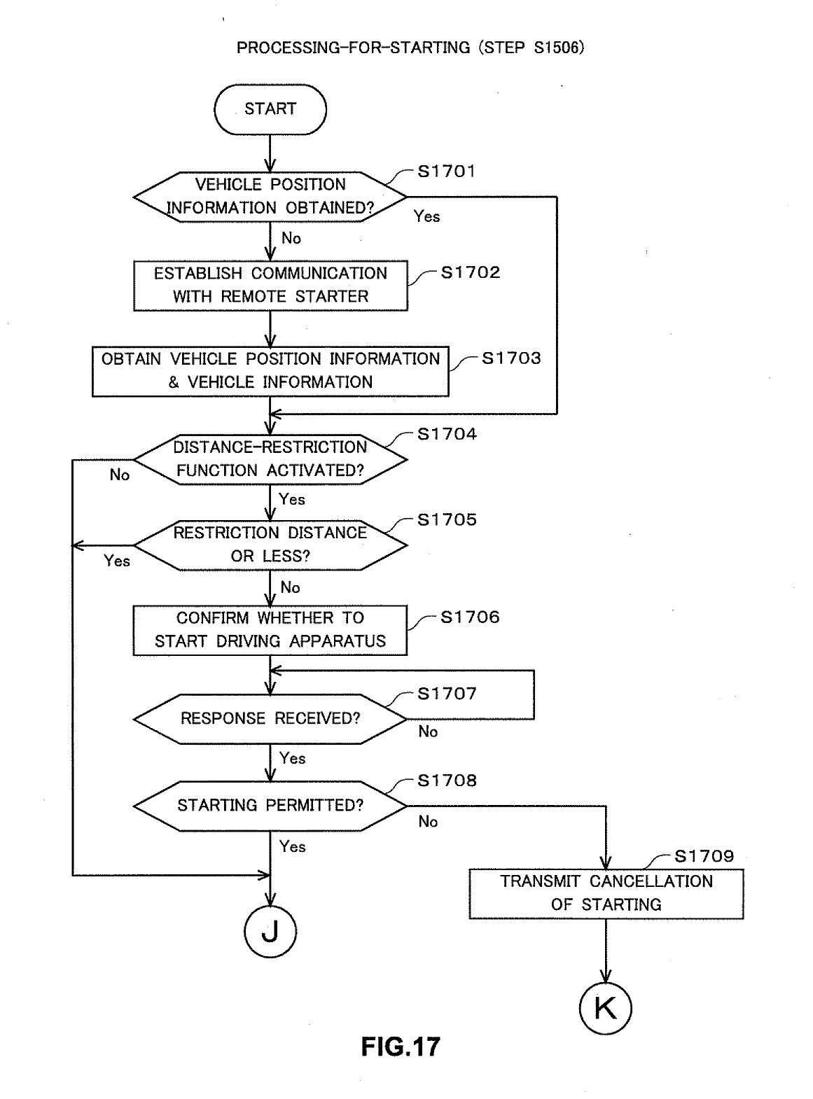

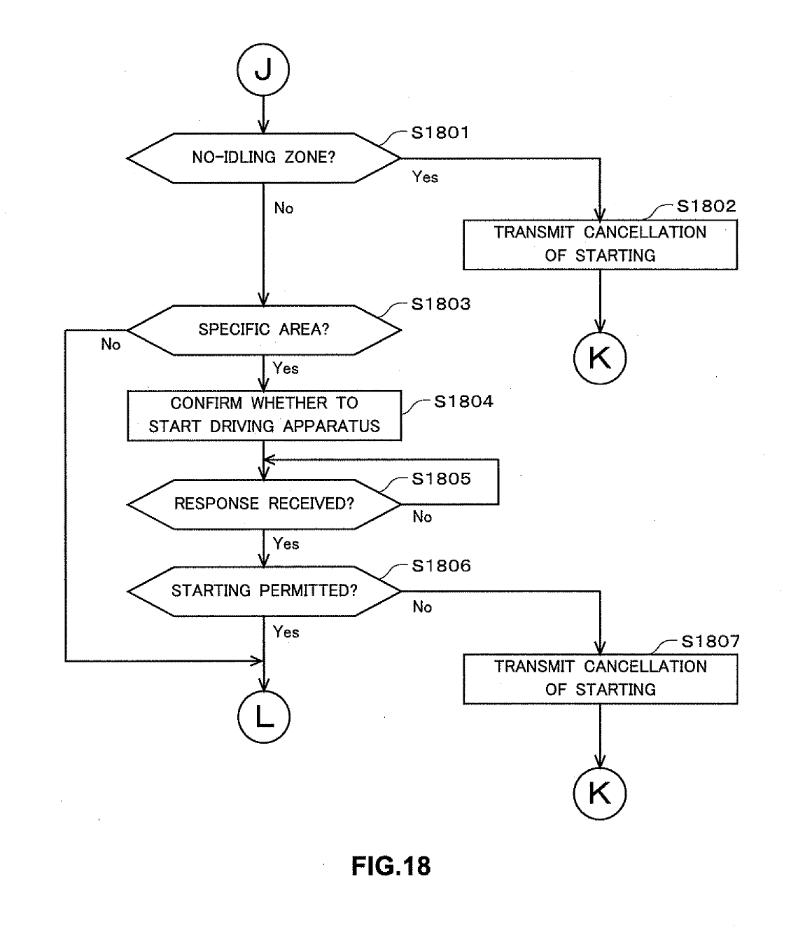

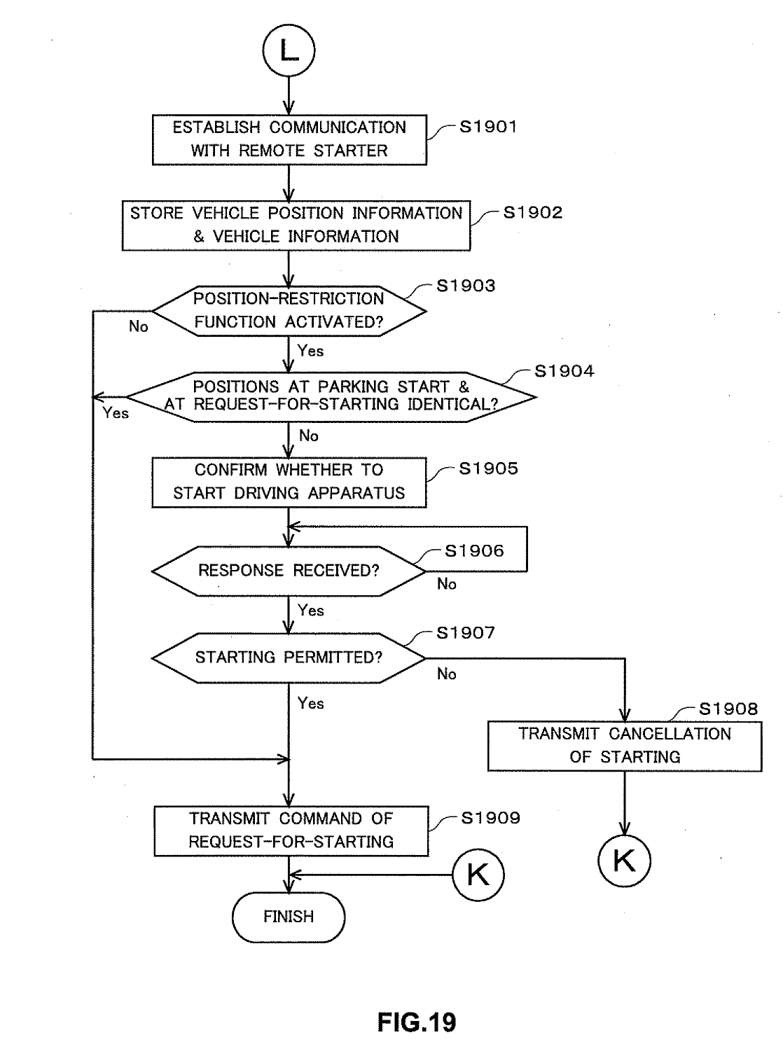

Next, the processing on the center 30 is described. Each of FIG. 14, FIG. 15, FIG. 16, FIG. 17, FIG. 18 and FIG. 19 shows a flowchart of the processing on the center 30. Described first is the processing for remote starting by communicating with the remote starter 10 and the mobile terminal 20 for transmitting and receiving information. Each of FIG. 14, FIG. 15 and FIG. 16 shows a flowchart of the processing for remote starting on the center 30.

The center 30 judges whether the request for connection has been received from the remote starter 10 (step 1401). The controller 31 makes this judgment based on the judgment whether the command of the request for communication connection has been received from the remote starter 10. When judging that the request for connection has been received from the remote starter 10 (Yes at the step S1401), the controller 31, if available, permits the communication connection with the remote starter 10 to establish the communication (step S1402). When the controller 31 judges that the request has not been received from the remote starter 10 (No at the step S1401), the procedure moves to the next step without execution of the processing for establishing the communication.

Next, the controller 31 judges whether any data have been received from the remote starter 10 (step S1403). Concretely, the controller 31 judges whether any data have been received via the communicator 32, or whether the source that has transmitted the data, if any, is the remote starter 10.

When judging that some data have been received from the remote starter 10 (Yes at the step S1403), the controller 31 stores the received data in the memory 33 (step S1404). Then, the information judging part 31a judges whether the reception data 33f include the vehicle position information 33b obtained at the time when the ignition condition has been changed to the off-state, that is, the vehicle position information at the time of parking start (step S1405).

When the information judging part 31a judges that the reception data 33f include the vehicle position information 33b at the time when the ignition is switched off (Yes at the step S1405), the controller 31 stores in the memory 33 the vehicle position information 33b as “the vehicle position information 33b at the time when the ignition is switched off,” that is, the parking start position (step S1406). When the reception data 33f are undetermined information, the undetermined information is stored in the memory 33 as “the vehicle position information 33b at the time when the ignition is switched off.”

Next, the information judging part 31a judges whether the reception data 33f include the vehicle position information 33b obtained at the time when the ignition condition has been switched on (step S1407). When the information judging part 31a judges that the reception data 33f include the vehicle position information 33b at the time when the ignition is switched on (Yes at the step S1407), the controller 31 deletes “the vehicle position information 33b at the time when the ignition is switched off” stored in the memory 33 (step S1408). Then, the procedure on the controller 31 moves to the next step (F in FIG. 14).

When the controller 31 judges that any data have not been received from the remote starter 10 (No at the step S1403), the procedure moves to the next step without any execution of the processing to respond to the judgment (F in FIG. 14). When the information judging part 31a judges that the reception data 33f do not include the vehicle position information 33b at the time when the ignition is switched off (No at the step S1405), and when the reception data 33f do not include the vehicle position information 33b at the time when the ignition is switched on (No at the step S1407), the procedure moves to the next step without any execution of the processing to respond to the judgment (F in FIG. 14).

Next, the center 30 judges whether the request for connection is transmitted by the mobile terminal 20 (step 1501). The controller 31 makes this judgment based on the judgment whether the command of the request for communication connection has been received from the mobile terminal 20. When judging that the request for connection has been received from the mobile terminal 20 (Yes at the step S1501), the controller 31, if available, permits the communication connection with the mobile terminal 20 to establish communication (step S1502). When the controller 31 judges that the request for connection has not been received from the mobile terminal 20 (No at the step S1501), the procedure moves to the next step without execution of the processing for establishing communication.

Next, the controller 31 judges whether any data have been received from the mobile terminal 20 (step S1503). Concretely, the controller 31 judges whether any data have been received via the communicator 32, or whether the source that has transmitted the data, if any, is the mobile terminal 20.

When judging that some data have been received from the mobile terminal 20 (Yes at the step S1503), the controller 31 stores the received data in the memory 33 (step S1504). The received data include the mobile-terminal position information. When the controller 31 judges that any data have not been received from the mobile terminal 20 (No at the step S1503), the procedure of the processing for remote starting is finished without any execution of the processing to respond to the judgment (G in FIG. 15).

After the data received from the mobile terminal 20 are stored, the information judging part 31a judges whether the reception data 33f include the command 33g of the request for starting (step S1505). When the information judging part 31a judges that the reception data 33f include the command 33g of the request for starting (Yes at the step S1505), the controller 31 executes the processing for starting (step S1506). Then, the procedure moves to the next step (H in FIG. 15). The processing for starting is detailed later. When the information judging part 31a judges that the reception data 33f do not include the command 33g of the request for starting (No at the step S1505), the procedure moves to the next step without any execution of the processing for starting (I in FIG. 15).

Next, the information judging part 31a judges whether the data received from the remote starter 10 include the time information at the time of starting (step S1601). When the information judging part 31a judges that the received data do not include the time information (No at the step S1601), the procedure moves to the next step without any execution of the processing to respond to the judgment. When judging that the received data include the time information (Yes at the step S1601), the information judging part 31a stores the received time information in the memory 33 as the time information 33h (step S1602).

Then, the timer 31e starts measuring the remaining time (step S1603). That is, when the starting time is received as the time information at the time of starting, the timer 31e, in a periodically-executed subroutine not shown in FIG. 16, reads out the starting time and the predetermined driving time from the time information 33h in the memory 33, and also obtains the current time from the GPS or the clock part 34. Then, the timer 31e calculates from the starting time and the current time the elapsed time of the driving of the driving apparatus. Next, the timer 31e calculates the remaining time by subtracting the elapsed time from the predetermined driving time. Then, the timer 31e continues the subtraction processing, and continues to count the real-time remaining time. When the remaining time is counted by the mobile terminal 20, this step S1603 may be omitted.

Then, the timer 31e transmits to the mobile terminal 20 via the communicator 32 the time information at the time of starting (step S1604). Only the starting time may be transmitted to the mobile terminal 20 as the time information to be transmitted to the mobile terminal 20. Also, the starting time and the remaining time at the time of starting may be transmitted together as described above. When the request for transmitting the remaining time is received from the mobile terminal 20, the timer 31e transmits the latest remaining time via the communicator 32.

Next, the information judging part 31a judges whether the reception data 33f from the mobile terminal 20 include the data indicating that the setting information 33d is to be changed (step S1605). When the information judging part 31a judges that the reception data 33f include the data indicating that the setting information 33d is to be changed (Yes at the step S1605), the controller 31 changes the setting information 33d based on the received data, and stores the changed setting information 33d in the memory 33 (step S1606). That is, the controller 31 executes the processing for rewriting the setting information 33d stored in the memory 33 so as to include the changed contents. When the information judging part 31a judges that the reception data 33f do not include any data indicating that the setting information 33d is to be changed (No at the step S1605), the procedure moves to the next step without any execution of the processing for changing the setting.

Next, the controller 31 executes the control of other functions (step S1607). Concretely, first, the information judging part 31a judges whether the reception data 33f include another command 33g. When the information judging part 31a judges that the reception data 33f include another command 33g, the controller 31 executes the processing to respond to the corresponding command 33g. When the information judging part 31a judges that the reception data 33f do not include any other command 33g, the controller 31 does not execute the processing. Then, the procedure of the processing for remote starting on the center 30 is finished.

Described next is the processing for starting executed by the controller 31 (step S1506). Each of FIG. 17, FIG. 18 and FIG. 19 shows a flowchart of the processing for starting executed by the controller 31.

After the processing for starting is started, the controller 31 first judges whether the vehicle position information has been obtained (step S1701). In the embodiment, when the vehicle is parked in the restricted area under the condition that the restriction mode of the remote starter 10 is activated, the processing for transmitting the vehicle position information is forbidden. In this case, the center 30 may not obtain the vehicle position information. Therefore, the controller 31 judges whether the vehicle position information at the time of parking start has been obtained from the remote starter 10 at the step S1701.

When the controller 31 judges that the vehicle position information has been obtained (Yes at the step S1701), the procedure moves to the next step of the processing for starting. When judging that the vehicle position information has not been obtained (No at the step S1701), the controller 31 executes the processing for obtaining the vehicle position information so as to execute the following steps of the processing for starting. First, the controller 31 transmits the command of the request for communication connection to the remote starter 10 via the communicator 32, and establishes communication with the remote starter 10 (step S1702).

After the communication is established, the controller 31 obtains the vehicle position information and the vehicle information from the remote starter 10 via the communicator 32 (step S1703). The received vehicle position information above is the vehicle position information that has been transmitted at the step S803 in FIG. 8, and indicates the parking position at the time when the remote starting has been requested. That is, the remote starter 10 is on standby while the ignition is in the off-state, and only the communicator 13 is activated. After the communication with the center 30 is established, the remote starter 10 obtains the vehicle position information by activating the controller 11 and the position information obtaining part 12, and then transmits the obtained vehicle position information to the center 30. The obtained vehicle position information is stored in the memory 33 as the vehicle position information 33b (that is, the parking start position).

As above, in the configuration of the embodiment, the processing on the remote starter 10 for transmitting the vehicle position information to the center 30 is forbidden when the vehicle is parked in the restricted area under the condition that the restriction mode of the remote starter 10 is activated. However, the center 30 needs to judge whether to transmit the request for starting when the user makes the request for starting. Therefore, in the configuration of the embodiment, the center 30 communicates with the remote starter 10 to make the request for transmitting the vehicle information.

The case where the center 30 has not obtained the parking start position when receiving the request for starting from the mobile terminal 20 may be occurred when the vehicle is parked in the restricted area, or when the remote starter 10 is not capable of transmitting the vehicle position information because of the remote starter 10 being in the out-of-service area for communications. In either case, it is undesirable that the center 30 transmit the request for starting to the remote starter 10. Therefore, when the parking start position has not been obtained, transmitting the request for starting may be forbidden without establishing communications with the remote starter 10 to make the request for transmitting the vehicle information. In this case, it is desirable that the data indicating the cancellation of the remote starting be transmitted to the mobile terminal 20 instead of execution of the step S1702 and the step S1703. This further reduces communication costs between the remote starter 10 and the center 30.

After the vehicle position information is obtained, the starting restricting part 31b judges whether the distance-restriction function is activated (step S1704). In the setting information 33d stored in the memory 33 of the center 30, the distance-restriction function is activated as initial settings. However, when the distance-restriction function is activated or deactivated on the mobile terminal 20, and when such information is transmitted as the setting information to the center 30, the setting information 33d is rewritten to the newly transmitted setting information. The starting restricting part 31b can judge whether the distance-restriction function is activated or deactivated in reference to the stored setting information 33d.

When the starting restricting part 31b judges that the distance-restriction function is not activated (No at the step S1704), the procedure of the controller 31 moves to the step for the processing for starting (J in FIG. 17). When judging that the distance-restriction function is activated (Yes at the step S1704), the starting restricting part 31b judges whether the distance between the mobile terminal 20 and the vehicle is equal to or shorter than the restriction distance (step S1705). Concretely, the starting restricting part 31b calculates the distance between the mobile terminal 20 and the vehicle by comparing the mobile-terminal position information 33c at the time of the request for starting that is stored in the memory 33 and the vehicle position information 33b at the time when the ignition is in the off-state (at the time of parking start). Then, the starting restricting part 31b compares the calculated distance and the restriction distance by reading out the restriction distance from the setting information 33d stored in the memory 33.

When the starting restricting part 31b judges that the calculated distance is equal to or shorter than the restriction distance as a result of the comparison (Yes at the step S1705), the procedure moves to the next step for the processing for starting (J in FIG. 17). When the starting restricting part 31b judges that the calculated distance is longer than the restriction distance (No at the step S1705), the procedure of the controller 31 moves to the step for executing the processing for confirming whether to continue the processing for starting (step S1706). Concretely, the controller 31 transmits to the mobile terminal 20 via the communicator 32 the information indicating that the distance between the mobile terminal 20 at the time of the request for starting and the vehicle at the time of parking start is longer than the restriction distance, and the inquiry information for confirmation on whether to continue the processing for starting.

Then, the controller 31 monitors whether the response to the inquiry has been received from the mobile terminal 20 (step S1707). When judging that the response has not been received from the mobile terminal 20 (No at the step S1707), the controller 31 continues the monitoring until receiving the response. When judging that the response has been received from the mobile terminal 20 (Yes at the step S1707), the controller 31 judges whether the contents of the response indicate permission to continue the processing for starting (step S1708).

When the controller 31 judges that the contents of the response from the mobile terminal 20 indicate permission to continue the processing for starting (Yes at the step S1708), the procedure moves to the next step of the processing for starting (J in FIG. 17). When judging that the contents of the response from the mobile terminal 20 indicate non-permission to continue the processing for starting (No at the step S1708), the controller 31 cancels the processing for starting and transmits the information indicating the cancellation to the mobile terminal 20 (step S1709), and the procedure of the processing for remote starting is finished (K in FIG. 17).

When the starting restricting part 31b judges that the calculated distance is longer than the restriction distance, the procedure of the processing for starting may be canceled without the controller 31 confirming on whether to continue the processing for starting. In this case also, the controller 31 executes the processing for transmitting to the mobile terminal 20 the information indicating that the processing for starting has been canceled. That is, when No is obtained at the step S1705, the procedure moves to the step S1709.

Next, the position judging part 31e judges whether the vehicle is in the no-idling zone (step S1801). As above, the no-idling zones are included in the map information 33e stored in the memory 33. The position judging part 31c reads out the vehicle position information 33b from the memory 33 (that is, the parking start position) and the no-idling zones included in the map information 33e. Then, the position judging part 31c judges whether the parking start position of the vehicle is in the no-idling zones by comparing the vehicle position information 33b and the no-idling zones. When the position judging part 31e judges that the parking start position of the vehicle is in the no-idling zone (Yes at the step S1801), since no vehicle is allowed to be kept in the idling condition by the remote starting, the controller 31 cancels the processing for starting without confirming with the mobile terminal 20 on whether to start the driving apparatus, and transmits the information indicating the cancellation to the mobile terminal 20 (step S1802), and the procedure of the processing for remote starting is finished (K in FIG. 18).

When judging that the parking start position of the vehicle is not in the no-idling zone (No at the step S1801), the position judging part 31c judges whether the parking start position of the vehicle is in the specific area (step S1803). Concretely, the position judging part 31c reads out the vehicle position information 33b (that is, the parking start position) from the memory 33 and the specific areas included in the map information 33e. Then, the position judging part 31c judges whether the parking start position of the vehicle is in the specific area by comparing the vehicle position information 33b and the specific areas.

When the position judging part 31c judges that the parking start position of the vehicle is not in the specific area (No at the step S1803), the procedure of the controller 31 moves to the next step of the processing for starting (L in FIG. 18). When the position judging part 31c judges that the parking start position of the vehicle is in the specific area (Yes at the step S1803), the procedure of the controller 31 moves to the step of the processing for confirming whether to continue the processing for starting (step S1804). Concretely, the controller 31 transmits to the mobile terminal 20 via the communicator 32 the information indicating that the parking start position of the vehicle is in the specific area, and the inquiry information for confirmation on whether to continue the processing for starting.

Then, the controller 31 monitors whether the response to the inquiry has been received from the mobile terminal 20 (step S1805). When judging that the response has not been received from the mobile terminal 20 (No at the step S1805), the controller 31 continues the monitoring until receiving the response. When judging that the response has been received from the mobile terminal 20 (Yes at the step S1805), the controller 31 judges whether the contents of the response indicate permission to continue the processing for starting (step S1806).

When the controller 31 judges that the contents of the response from the mobile terminal 20 indicate permission to continue the processing for starting (Yes at the step S1806), the procedure moves to the next step of the processing for starting (L in FIG. 18). When judging that the contents of the response from the mobile terminal 20 indicate non-permission to continue the processing for starting (No at the step S1806), the controller 31 cancels the processing for starting and transmits the information indicating the cancellation to the mobile terminal 20 (step S1807), and the procedure of the processing for remote starting is finished (K in FIG. 18).

When it is judged that the parking start position of the vehicle is in the specific area, the controller 31 may cancel the processing for starting without confirming on whether to continue the processing for starting. In this case also, the controller 31 executes the processing for transmitting to the mobile terminal 20 the information indicating that the processing for starting has been canceled. That is, when Yes is obtained at the step S1803, the procedure moves to the step S1807.

Next, the controller 31 transmits the command of the request for communication connection to the remote starter 10 via the communicator 32, and establishes the communication with the remote starter 10 (step S1901). After the communication is established, the controller 31 receives the vehicle position information and the vehicle information from the remote starter 10 via the communicator 32 (step S1902). The received vehicle position information above is the vehicle position information that has been transmitted at the step S803 in FIG. 8, and indicates the parking position at the time when the remote starting has been requested. That is, the remote starter 10 is on standby while the ignition is in the off-state, and only the communicator 13 is activated. After the communication with the center 30 is established, the remote starter 10 obtains the vehicle position information by activating the controller 11 and the position information obtaining part 12, and then transmits the obtained vehicle position information to the center 30.

When judging that the vehicle position information has not been obtained at the step S1701, the controller 31 executes the processing for obtaining the vehicle position information by establishing the communication with the remote starter 10. That is, when No is obtained at the step S1701, the step S1702 and the step S1703 are executed. Therefore, at the step S1901, the communication with the remote starter 10 has been established, and the vehicle position information has been obtained. Therefore, when Yes is obtained at the step S1701, the controller 31 needs to execute the processing of the step S1901 and the step S1902. When No is obtained at the step S1701, the controller 31 need not execute the processing of the step S1901. Furthermore, the controller 31 may not, or may, execute the processing of the step S1902.

Next, the starting restricting part 31b judges whether the position-restriction function is activated (step S1903). In the setting information 33d stored in the memory 33 of the center 30, the position-restriction function is activated as initial settings. However, when the position-restriction function is activated or deactivated on the mobile terminal 20, and when such information is transmitted as the setting information to the center 30, the setting information 33d is rewritten to the newly transmitted setting information. The starting restricting part 31b can judge whether the position-restriction function is activated or deactivated in reference to the stored setting information 33d.

When it is judged that the position-restriction function is not activated (No at the step S1903), the starting directing part 31d transmits the command of the request for starting to the remote starter 10 (step S1909), and the procedure of the processing for remote starting is finished. When judging that the position-restriction function is activated (Yes at the step S1903), the starting restricting part 31b judges whether the vehicle position at the time of parking start (parking start position) is identical to the vehicle position at the time of the request for remote starting that has been received at the step S1902 (step S1904). Concretely, the starting restricting part 31b judges the difference between the vehicle position information 33b when the ignition is switched off (that is, the parking start position) which is stored in the memory 33, and the vehicle position information 33b received at the step S1902 (that is, the parking position at the time of the request for remote starting), by comparing them with each other.

When the vehicle position information at the time of parking start is identical to the vehicle position information at the time of the request for starting, the starting restricting part 31b judges that the positions are identical. When the vehicle position information at the time of parking start is different from the vehicle position information at the time of the request for starting, or when either of them is undetermined information, the starting restricting part 31b judges that the positions are different. Furthermore, when both of the vehicle position information at the time of parking start and the vehicle position information at the time of the request for starting are undetermined information, the starting restricting part 31b judges that the positions are identical.

Then, the starting restricting part 31b reads out the restriction conditions included in the setting information 33d stored in the memory 33, and compares the read-out restriction conditions and the difference between the positions. As the restriction conditions in the embodiment, when the positions are identical, the remote starting is permitted; when the positions are different, confirmation on whether to continue the processing for starting is required.

As a result of the comparison, when it is judged that the positions are identical (Yes at the step S1904), the starting directing part 31d transmits the command of the request for starting to the remote starter 10 (step S1909), and the procedure of the processing for remote starting is finished. The judgment that the positions are identical indicates that the vehicle position at the time of parking start is identical to the current vehicle position. The judgment is made on the basis that the vehicle stays without moving against user's will.

When it is judged that the positions are different (No at the step S1904), the procedure of the controller 31 moves to the step for executing the processing for confirming whether to continue the processing for starting (step S1905). Concretely, the controller 31 transmits to the mobile terminal 20 via the communicator 32 the information indicating that the vehicle position at the time of parking start is different from the vehicle position at the time of the request for starting, and the inquiry information for confirming whether to continue the processing for starting. The judgment that the two positions are different indicates that the vehicle position at the time of parking start is different from the current vehicle position. It is assumed that the vehicle has been moved against user's will such as by theft or tow-away.

Then, the controller 31 monitors whether the response to the inquiry has been received from the mobile terminal 20 (step S1906). When judging that the response has not been received from the mobile terminal 20 (No at the step S1906), the controller 31 continues the monitoring until receiving the response. When judging that the response has been received from the mobile terminal 20 (Yes at the step S1906), the controller 31 judges whether the contents of the response indicate permission to continue the processing for starting (step S1907).

When the controller 31 judges that the contents of the response from the mobile terminal 20 indicate permission to continue the processing for starting (Yes at the step S1907), the starting directing part 31d transmits the command of the request for starting to the remote starter 10 (step S1909), and the procedure of the processing for remote starting is finished. When judging that the contents of the response from the mobile terminal 20 indicate non-permission to continue the processing for starting (No at the step S1907), the controller 31 cancels the processing for starting, transmits the information of the cancellation to the mobile terminal 20 (step S1908), and the procedure of the processing for remote starting is finished (K in FIG. 19).

When it is judged that the two positions are different, the procedure of the processing for starting may be canceled without the controller 31 executing the processing for confirming on whether to continue the processing for starting. In this case also, the controller 31 executes the processing for transmitting to the mobile terminal 20 the information indicating that the processing for starting has been canceled. That is, when No is obtained at the step S1904, the procedure moves to the step S1908.

When all of the necessary data have been transmitted and received between the center 30 and the remote starter 10, the center 30 automatically terminates the communication with the remote starter 10. In an example, when the request for connection is transmitted by the remote starter 10 (step S1401), the controller 31 automatically terminates the communication with the remote starter 10 after data are received from the remote starter 10. In the case where the center 30 establishes the communication with the remote starter 10, the controller 31 automatically terminates the communication when judging that the remote starter 10 has completed transmitting a series of the responses to the received command, such as the command of the request for starting (step S1909). The judgment that the remote starter 10 has completed transmitting the series of the responses is made when information of starting completion or time information at the time of starting has been received.

In the configuration described above, the remote starter 10 transmits the time information at the time of starting the remote starting of the vehicle to the center 30 at the time of starting, which allows the center 30 to obtain and to keep the time information at the time of starting. Therefore, when the user checks the remaining time before stopping the driving of the driving apparatus (remaining time of warming-up operation), the mobile terminal 20 can obtain the remaining time simply by communicating with the center 30. That is, the center 30 need not communicate with the remote starter 10 every time the user checks the remaining time, which reduces communication costs.

Further, in the configuration described above, the remote starter 10 transmits the time information at the time of starting the remote starting of the vehicle to the center 30 at the time of starting, and the center 30 transmits the time information to the mobile terminal 20. Therefore, when the user checks the remaining time before stopping the driving of the driving apparatus (remaining time of warming-up operation), the mobile terminal 20 can check the remaining time by the mobile terminal 20 itself without communicating with the center 30 and the remote starter 10. That is, the center 30 need not communicate with the remote starter 10 every time the user checks the remaining time, and the mobile terminal 20 need not communicate with the center 30, which reduces the communication costs further.

Further, after the communication is established so that the mobile terminal 20 transmits the request for starting to the center 30, the center 30 establishes the communication with the remote starter 10 to obtain the time information at the time of starting. After the center 30 transmits the obtained time information to the mobile terminal 20, the communication between the mobile terminal 20 and the center 30 is terminated. That is, during one-time communication connection at the time of the request for starting, the mobile terminal 20 transmits the request for starting and obtains the time information at the time of starting, which results in no-occurrence of communication costs only for checking the remaining time.

Further, in the case where the mobile terminal 20 communicates with the center 30 and the remote starter 10 to obtain the time information when the user checks the remaining time, it takes time before the mobile terminal 20 displays the remaining time because of the communication's response delay. In the embodiment, however, since the mobile terminal 20 stores the time information at the time of starting that has been received at the time of starting, the user can check the remaining time immediately.

In the distance-restriction function (step S1704 to step S1709) and the restriction function in the no-idling zone and the specific area (step S1801 to step S1807) based on the processing for remote starting described above, the center 30 judges on whether to remotely start the driving apparatus by use of the vehicle position information received at the time when the ignition is switched off. Only when the remote starting is available, the center 30 transmits the command of the request for starting by establishing the communication with the remote starter 10. Therefore, it is no need for the center 30 to establish the communication with the remote starter 10 every time the request for remote starting is received from the mobile terminal 20, which reduces communication costs.

The position-restriction function (step S1903 to step S1908) restricts the starting when the vehicle position at the time of parking start is different from the vehicle position at the time of the request for starting, that is, when the starting is not suitable, which prevents useless starting.

When the vehicle is parked in the no-idling zone or the specific area under the condition that the restriction mode of the remote starter 10 is activated, transmitting the vehicle position information at the time of parking start is forbidden, which reduces the communication costs further.

In the embodiment described above, the restriction mode (step S603 in FIG. 6) for restricting transmission of the vehicle position information at the time of parking start is provided on the remote starter 10, and transmitting the vehicle position information is restricted based on whether the vehicle is parked in the restricted area when the restriction mode is activated. However, the restriction mode may not be necessary. In this case, when the vehicle is parked in the restricted area, transmitting the vehicle position information from the remote starter 10 to the center 30 is completely forbidden.

Further, in the embodiment described above, the center 30 executes, as the processing for remote starting, the processing for starting based on the distance-restriction function, the processing for starting based on the judgment in terms of the no-idling zone and the specific area, and the processing for starting based on the position-restriction function. However, it is not necessary to execute all of the processing. One or more processing for starting may be executed individually or in appropriate combination.

Further, in the embodiment described above, the information of the ignition switched off is used as the parking start information. When the ignition condition is switched to the off-state, it is judged that parking has started. Thus, the vehicle position information is transmitted to the center. However, making the judgment whether the parking has started is not limited to this case. Other kinds of the vehicle information are acceptable as long as the judgment whether parking has started can be made based on them. In an example of using an engine as the driving apparatus, the judgment that parking has started may be made based on the engine revolution indicating that the engine has stopped. In another example on the vehicle equipped with a keyless entry apparatus, the judgment that parking has started may be made based on the information indicating that a door has been locked by the keyless entry apparatus. The point is just transmitting the vehicle position information after judging that parking has started.

Further, in the embodiment described above, the mobile terminal 20 displays the driving apparatus's driving remaining time. However, the mobile terminal 20 may display the elapsed time since the beginning of the starting of the driving apparatus instead of the remaining time. In this case, the elapsed time that is calculated based on starting beginning time may be displayed.

Further, in the embodiment described above, various functions are executed by software, specifically by CPU processing based on programs. However, some of these functions may be executed by electrical hardware circuits. Contrarily, some of the functions executed through hardware circuits in the above descriptions may be executed through software.

While the invention has been shown and described in detail, the foregoing description is in all aspects illustrative and not restrictive. It is therefore understood that numerous other modifications and variations can be devised without departing from the scope of the invention.

What is claimed is:

1. A remote starter that is installed in a vehicle for executing starting control of a driving apparatus of the vehicle, and that executes the starting control of the driving apparatus in response to a request for starting received from an information processor that is located outside the vehicle, the remote starter comprising:
a communicator that communicates with the information processor by transmitting and receiving information; and
a controller that obtains time information at a time of starting the driving apparatus, wherein
the communicator transmits the time information at the time of starting to the information processor at the time of starting the driving apparatus in response to the request for starting received from the information processor.

2. The remote starter of claim 1, wherein
the time information at the time of starting is a starting time of the driving apparatus, or a time corresponding to a remaining time before stopping driving of the driving apparatus.

3. The remote starter of claim 1, wherein
the controller measures a time corresponding to a remaining time before stopping driving of the driving apparatus.

4. The remote starter of claim 1, wherein
the controller obtains the time information at the time of starting from time information included in a Global Positioning System that is installed in the vehicle, and obtains the time information at the time of starting from a clock that is included in the remote starter when the time information at the time of starting cannot be obtained from the time information included in the Global Positioning System.

5. An information processor that is configured to be communicatively coupled to a mobile terminal and a remote starter that is installed in a vehicle, and that transmits a request for starting a driving apparatus of the vehicle to the remote starter based on the request for starting received from the mobile terminal, the information processor comprising:
a communicator that communicates with the mobile terminal and the remote starter by transmitting and receiving information, wherein
upon receiving time information at a time of starting the driving apparatus from the remote starter in response to the request for starting transmitted by the communicator to the remote starter, the communicator transmits the time information at the time of starting to the mobile terminal.

6. The information processor of claim 5, wherein
the time information at the time of starting is a starting time of the driving apparatus, or a time corresponding to a remaining time before stopping driving of the driving apparatus.

7. The information processor of claim 6, further comprising:
a timer that measures time, wherein
when the time information at the time of starting is the starting time of the driving apparatus, the timer measures the time corresponding to the remaining time before stopping the driving of the driving apparatus based on the starting time.

8. A mobile terminal that transmits a request for starting to an information processor which transmits the request for starting to a remote starter executing starting control of a driving apparatus of a vehicle, the mobile terminal comprising:
a communicator that communicates with the information processor by transmitting and receiving information;
a timer that measures time; and
a display that displays information, wherein
when the communicator receives time information at a time of starting the driving apparatus from the information processor in response to the request for starting transmitted to the information processor,
the timer measures a time corresponding to a remaining time before stopping driving of the driving apparatus based on the time information at the time of starting, and
the display displays the time corresponding to the remaining time before stopping the driving of the driving apparatus.

9. The mobile terminal of claim 8, wherein
the time information at the time of starting is a starting time of the driving apparatus, or the time corresponding to the remaining time before stopping the driving of the driving apparatus.

10. A remote starting system comprising:
a remote starter;
an information processor; and
a mobile terminal,
the remote starter being installed in a vehicle and executing starting control of a driving apparatus of the vehicle in response to a request for starting received from the information processor that is located outside the vehicle, the remote starter including:
a communicator that communicates with the information processor by transmitting and receiving information; and
a controller that obtains time information at a time of starting the driving apparatus, wherein
the communicator transmits the time information at the time of starting to the information processor at the time of starting the driving apparatus in response to the request for starting received from the information processor;
the information processor being configured to be communicatively coupled to the mobile terminal and the remote starter, the information processor transmitting the request for starting the driving apparatus of the vehicle to the remote starter based on the request for starting received from the mobile terminal, the information processor including:
a communicator that communicates with the mobile terminal and the remote starter by transmitting and receiving information, wherein
upon receiving the time information at the time of starting the driving apparatus from the remote starter in response to the request for starting transmitted by the communicator to the remote starter, the communicator transmits the time information at the time of starting to the mobile terminal;
the mobile terminal transmitting the request for starting to the information processor which transmits the request for starting to the remote starter executing the starting control of the driving apparatus of the vehicle, the mobile terminal including:
a communicator that communicates with the information processor by transmitting and receiving information;
a timer that measures time; and
a display that displays information, wherein
when the communicator receives the time information at the time of starting the driving apparatus from the information processor in response to the request for starting transmitted to the information processor,
the timer measures a time corresponding to a remaining time before stopping driving of the driving apparatus based on the time information at the time of starting, and
the display displays the time corresponding to the remaining time before stopping the driving of the driving apparatus.

11. A remote starter that is installed in a vehicle for executing starting control of a driving apparatus of the vehicle, the remote starter comprising:
a communicator that communicates with an information processor by transmitting and receiving information, the information processor being located outside the vehicle; and
a controller that obtains time information at a time of starting the driving apparatus, wherein
the communicator transmits the time information at the time of starting to the information processor at the time of starting the driving apparatus in response to a request for starting.
